(19) United States
(12) Patent Application Publication
(10) Pub. No.: US 2021/0090144 A1
(43) Pub. Date: Mar. 25, 2021

(54) METHOD AND APPARATUS FOR CONSOLIDATING ORDERS

(71) Applicant: Gil Hoon Chang, Seoul (KR)

(72) Inventor: Gil Hoon Chang, Seoul (KR)

(21) Appl. No.: 17/111,665

(22) Filed: Dec. 4, 2020

Related U.S. Application Data
(63) Continuation-in-part of application No. 15/091,872, filed on Apr. 6, 2016, now abandoned.
Application No. 15/091,872 is a continuation-in-part of application No. PCT/KR2015/005334, filed on May 28, 2015.

(30) Foreign Application Priority Data
May 28, 2014 (KR) 10-2014-0064208
Apr. 6, 2015 (KR) 10-2015-0048629
Nov. 27, 2015 (KR) 10-2015-0167608

(51) Int. Cl. G06Q 30/06; G06Q 30/02; G06Q 50/00; G06Q 20/12; G06Q 20/02; G06F 21/62

(52) U.S. Cl. CPC G06Q 30/0605; G06Q 30/0633; G06Q 30/0641; G06Q 30/0205; G06F 21/6245; G06Q 20/127; G06Q 30/0609; G06Q 20/02; G06Q 50/01

(57) ABSTRACT

Provided are an ordering method and apparatus for consolidating purchase orders for products or services into one order under a particular condition and collectively processing the purchase orders when a plurality of purchasers in an acquaintance relationship make the purchase orders using electronic communications devices. According to the ordering method and apparatus, when a single purchaser makes an order, a group consisting of potential purchasers who can make a group order is created using acquaintance information of the single purchaser, and order information of the single purchaser is shared among the group members. According to the ordering method and apparatus, a group consisting of group purchasers desiring ordering among the group members is created, and group order information is generated using order information received from the members. The generated group order information is transferred to a seller, and thus an order is finally made. According to the ordering method and apparatus, when a plurality of purchasers make orders for products or services through electronic communications devices, the orders are consolidated into a group order and transferred to a seller. Therefore, it is possible to receive an incentive for the group order provided by the seller, and the respective purchasers can request proxy purchases of a particular purchaser without explaining their orders one by one.

### CROSS-REFERENCE TO RELATED APPLICATION

This application is a continuation-in-part of U.S. patent application Ser. No. 15/091,872, which is a continuation-in-part of PCT international application S/N PCT/KR2015/005334 filed on May 28, 2015, which claims the benefit of Korean Patent Application S/N KR10-2014-0064208 filed on May 28, 2014 and Korean Patent application S/N KR10-2015-0048629 filed on Apr. 6, 2015, each of which is hereby incorporated in its entirety by reference. This application further claims foreign priority under Paris Convention and 35 U.S.C. § 119 to Korean Patent Application S/N KR10-2015-0167608 filed on Nov. 27, 2015 with the Korean Intellectual Property Office, which is hereby incorporated in its entirety by reference.

### FIELD OF THE INVENTION

The present invention relates to an ordering method and apparatus for consolidating purchase orders for products or services into one order under a particular condition and collectively processing the purchase orders when the purchase orders are made using electronic communications devices.

### BACKGROUND

Currently, a method of purchasing products or services online using a personal computer (PC), a smart phone, etc. is widely in use. However, in such an existing method, an order from only one purchaser is processed. Therefore, in order for a plurality of purchasers to make orders for products or services which are on sale by the same seller, each of the purchasers should make an individual order, or a particular purchaser should be notified of orders and then should input all of the orders.

### SUMMARY OF THE INVENTION

The present embodiment is directed to providing a method and apparatus for sharing order information among a plurality of purchasers and consolidating orders of the plurality of purchasers into one and making an order when the plurality of purchasers intend to purchase products or services on sale by the same seller through electronic communications devices.

The present embodiment is also directed to providing a method and apparatus for enabling persons in a predetermined relationship with a particular purchaser to make orders for a particular product or service together when the particular purchaser attempts to purchase the particular product or service using an electronic communications device.

The present embodiment is also directed to providing a method and apparatus for automatically consolidating orders into one order when a plurality of purchasers make the orders for products or services on sale by the same seller using electronic communications devices at the same point in time or very similar points in time.

The present embodiment is also directed to providing a payment method and apparatus for a case in which a plurality of purchasers purchase products or services on sale by the same seller through a consolidated order.

To solve the aforementioned technical problems, the present invention can be implemented by the following embodiments.

According to an aspect of the present invention, an ordering method using electronic communications devices of purchasers having a communications function is performed by an ordering server and includes: a first order information receiving operation of receiving order information for at least one product or service from a first purchaser through an electronic communications device; a first purchaser group creating operation of creating a first purchaser group consisting of a plurality of members including the first purchaser using the received order information; a second order information receiving operation of separately receiving order information from the members constituting the first purchaser group; a second purchaser group creating operation of creating a second purchaser group consisting of the first purchaser and the members who have separately transmitted the order information; an operation of generating group order information using the order information received in the first and second order information receiving operations; and a final ordering operation of making an order by transferring the group order information to a seller.

According to an embodiment of the present invention, the first purchaser group may include acquaintances personally designated by the first purchaser.

According to an embodiment of the present invention, the first purchaser group creating operation may include creating the first purchaser group based on acquaintance information received from the first purchaser and whether or not each purchaser is within a predetermined distance from the first purchaser or first purchaser selection information of each purchaser.

According to an embodiment of the present invention, the members of the first purchaser group may be persons who are at least within a predetermined distance from the first purchaser or have had experiences with making a group order with the first purchaser.

According to an embodiment of the present invention, the first purchaser group may be automatically created by the server using personal information of the first purchaser, and the personal information of the first purchaser may include at least one of location information of the first purchaser, purchase history information, social network subscription information, residence information, workplace information, contact information stored in the electronic communications device, and subscription information of a particular service provider.

According to an embodiment of the present invention, the ordering method may further include transmitting a condition for purchase and a current state of purchase to the members of the second purchaser group in real time every time second order information is received.

According to an embodiment of the present invention, the group order information may include order identifiers, ordered product information, and time information related to preparation of ordered products, and the order identifiers and the time information related to preparation of the ordered products included in the group order information may be used by the seller to prepare the ordered products so that at least one member of the second purchaser group can be provided with the ordered products at a sales spot.

According to another aspect of the present invention, an ordering method using electronic communications devices of purchasers having a communications function is performed by an ordering server and includes: an operation of receiving order information for at least one product or service from a plurality of purchasers through electronic communications devices; a purchaser group creating operation of creating a purchaser group with purchasers satisfying a condition for making a group order among the plurality of purchasers from whom the order information has been received; an order notifying operation of transmitting to the plurality of purchasers other than a purchaser a notification message for notifying that the purchaser has made an order; an operation of generating group order information using the received order information; and an operation of transmitting the generated group order information to a seller.

According to an embodiment of the present invention, the condition for making a group order may be that purchasers be at least within a predetermined distance from the seller, have been registered in contact lists of each other's electronic communications devices, subscribe to an identical social network, or have had experiences with making a group order together.

According to an embodiment of the present invention, the ordering method may further include transmitting a condition for purchase and a current state of purchase to the members of the purchaser group in real time every time order information is received.

According to an embodiment of the present invention, the group order information may include order identifiers, ordered product information, and time information related to preparation of ordered products, and the order identifiers and the time information related to preparation of the ordered products included in the group order information may be used by the seller to prepare the ordered products so that at least one member of the purchaser group can be provided with the ordered products at a sales spot.

According to an embodiment of the present invention, the ordering method may further include: a purchaser-server payment operation of receiving, by the server, payment information of separate orders from the members of the purchaser group and making payment between at least one of the members of the purchaser group and the server; and a server-seller payment operation of making, by the server, payment for the orders to the seller after the purchaser-server payment operation.

According to an embodiment of the present invention, when an incentive for the orders is provided by the seller, the incentive may be distributed to the members of the purchaser group by the server under predetermined rules.

According to another aspect of the present invention, a server for collectively processing a plurality of orders for products or services through electronic communications devices of purchasers having a communications function, the server including: a communication unit configured to communicate with an external electronic communications device; a purchaser group creation unit configured to create at least one purchaser group using at least one piece of order information received through the communication unit; a storage configured to store information related to members of the at least one purchaser group; and an order processing unit configured to generate group order information by consolidating order information separately received from the members of the at least one purchaser group.

According to an embodiment of the present invention, the at least one purchaser group may be a first purchaser group formed of potential purchasers and a second purchaser group formed of persons who have made up their minds to make purchases among the members of the first purchaser group.

According to an embodiment of the present invention, the members of the first purchaser group may be at least within a predetermined distance from a first purchaser, may be within a predetermined distance from a seller, may have been registered in contact lists of each other's electronic communications devices, may have had experiences with making a group order together, or may subscribe to an identical social network.

According to an embodiment of the present invention, the at least one purchaser group may be created according to a seller of products or services.

According to an embodiment of the present invention, the server may further include a location analyzer configured to analyze locations of the members of the at least one purchaser group, and analyze a time needed for a representative purchaser selected from among the members of the at least one purchaser group to arrive at a seller of products or services.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows a server for e-commerce ordering according to an exemplary embodiment of the present invention;

FIG. 2 shows seller tags according to an exemplary embodiment of the present invention;

FIG. 3 shows an exemplary embodiment of process of making a group order according an embodiment of the present invention;

FIG. 4 is a flowchart of a method for e-commerce ordering according to an exemplary embodiment of the present invention;

FIGS. 5 to 7 are flowcharts of methods for e-commerce ordering according to other exemplary embodiments of the present invention;

FIGS. 8 to 10 show processes in which methods for e-commerce ordering according to exemplary embodiments of the present invention are executed among purchasers, a server, and a seller;

FIGS. 11 and 15 show processes in which relationships expand to a group of a plurality of purchasers in a method for e-commerce ordering according to an exemplary embodiment of the present invention;

FIGS. 16 to 18 show an embodiment in which the table arrangement information and acquaintance information are used according an embodiment of the present invention;

FIG. 19 is a sequence diagram showing an ordering method which is an exemplary embodiment of the present invention;

FIGS. 20 to 24 shows a process in which order information of a purchaser is shared or blocked with other purchasers according an embodiment of the present invention;

FIG. 25 is a sequence diagram showing an ordering method which is an exemplary embodiment of the present invention;

FIG. 26 shows one process of an ordering method according to an exemplary embodiment of the present invention;

FIG. 27 is a sequence diagram showing a payment method included in an ordering method which is an exemplary embodiment of the present invention;

FIG. 28 is a sequence diagram showing a payment method included in an ordering method which is an exemplary embodiment of the present invention; and

FIG. 29 shows a server according to an exemplary embodiment of the present invention.

FIG. 30 shows an exemplary embodiment in which a server uses seller tags according to an embodiment of the present invention.

### DETAILED DESCRIPTION OF EXEMPLARY EMBODIMENTS

Before the detailed description of the present invention, an outline of a solution to the problem to be solved by the present invention or the core of technical spirit is presented first for convenience of understanding.

A method for e-commerce ordering according to an exemplary embodiment of the present invention includes an operation of receiving order information of one purchaser, an operation of searching for other purchasers related to the received order information, an operation of generating group order information using order information of the other purchasers and the order information of the single purchaser, and an operation of transmitting the generated group order information to a seller and the purchasers related to the group order information.

Hereinafter, exemplary embodiments of the present embodiment will be described in detail with reference to the accompanying drawings so that those of ordinary skill in the art to which the present invention pertains can easily embody the present invention. However, these exemplary embodiments are intended to describe the present invention more clearly, and it would be obvious to those of ordinary skill in the art that the scope of the present invention is not limited by the exemplary embodiments.

Configurations of the present invention for clarifying solutions to the problems to be solved by the present invention will be described in detail based on exemplary embodiments of the present invention with reference to the accompanying drawings. In describing a drawing, elements of other drawings may be used as needed. When it is determined that a detailed description of known relevant technologies or configurations may unnecessarily obscure the gist of the present invention in the description of exemplary embodiments of the present invention, the detailed description will be omitted.

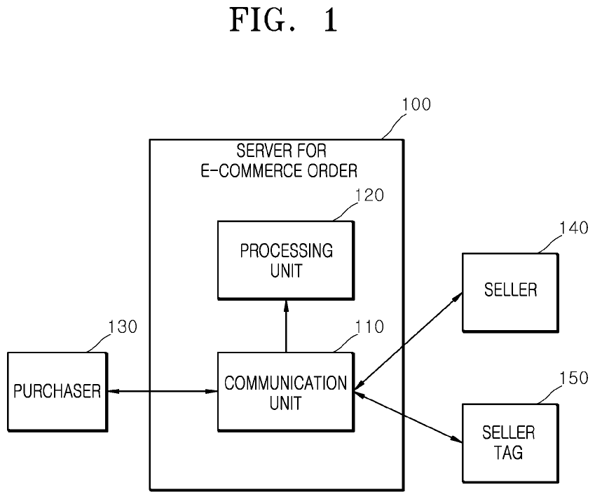

FIG. 1 shows a server for e-commerce ordering according to an exemplary embodiment of the present invention.

A server 100 for e-commerce ordering according to an exemplary embodiment of the present invention includes a communication unit 110 and a processing unit 120. A storage for storing order information or seller information may be further included.

The communication unit 110 receives order information of one purchaser and transmits group order information to a seller and purchasers related to the group order information.

More specifically, the communication unit 110 receives order information of one purchaser to generate group order information. The order information may include one or more of a purchaser identifier, an order identifier, ordered product information, seller information, location information, and payment information. The ordered product information may include one or more of a type of a product, quantity, the time of reservation, number of persons making reservations, and anything unusual. A group order representative identifier, a group identifier, a group order identifier, a personal identifier of a representative expanding to a group identifier, a individual order identifier of the representative expanding to a group order identifier, identifiers of individuals included in a group, identifiers of individual orders included in the group order, etc. may be included. The ordered product information may be ordered product information of the single purchaser or ordered product information of the purchasing group. The group order information may be specified by one group order identifier or purchasing group identifier. The seller information may include a seller or store identifier. A purchaser may acquire the seller information from a seller tag 150 provided in a store. The seller tag 150 may be a near field communication (NFC) code, a quick response (QR) code, or a beacon. The seller tag 150 may be implemented as a tag terminal capable of communication and may receive information on a purchaser 130 and communicate with the server 100 when connecting to the purchaser 130. The purchaser 130 may be a terminal of a purchaser and may communicate with a purchaser client through a communications session or an application connection session. A seller 140 may also be a terminal of a seller and may communicate with a seller client through a communications session or an application connection session.

The purchaser may connect to the server, search for information on a product to purchase, and make an order. When the purchaser has acquired seller information by receiving the seller information, it is possible to immediately issue an order to a seller of the product to purchase by transmitting seller information upon connecting to the server. The information of the seller can be acquired when the purchaser belonging to the purchasing group recognizes a seller tag installed in a store of the seller. It is possible to acquire the information on the seller by recognizing the tag installed in the store through the terminal of the purchaser. The acquired seller information may be transmitted to all purchasers belonging to the purchasing group for sharing. Information on the store stored in an order history of the purchaser may be used as the seller information, or the seller information may be acquired through an advertisement, etc. of the seller or through various means of communication at a location other than the store.

Group order information generated by the processing unit 120 from the received order information of the single purchaser is transmitted to the seller and the purchasers related to the group order information.

The communication unit 110 may receive the order information from the purchaser 130, the seller 140, or the seller tag 150. The communication unit 110 may receive the order information from the purchaser 130, receive the order information of the purchaser confirmed by the seller from the seller 140, or receive the order information from the seller tag 150 through a connection between the purchaser and the seller tag. The seller tag 150 may be installed by the seller, provided in the store as a tag used by the seller to receive order information, or installed close to the store along a route to the store. When the purchaser connects to the seller tag 150, it is possible to receive the order information from the purchaser or the seller tag. When the seller tag 150 is implemented as a tag terminal capable of communication and the purchaser connects to the seller tag 150, the seller tag 150 may acquire information on the purchaser. The information on the purchaser may be a unique identifier of the terminal of the purchaser or stored order information. As a group formed of one or more purchasers, the purchasing group may be given one purchasing group identifier to connect to the server with the purchasing group identifier and may be provided with information on a product to purchase and make an order. Two or more persons may gather and form a purchasing group, or a single person may form a purchasing group and gather members.

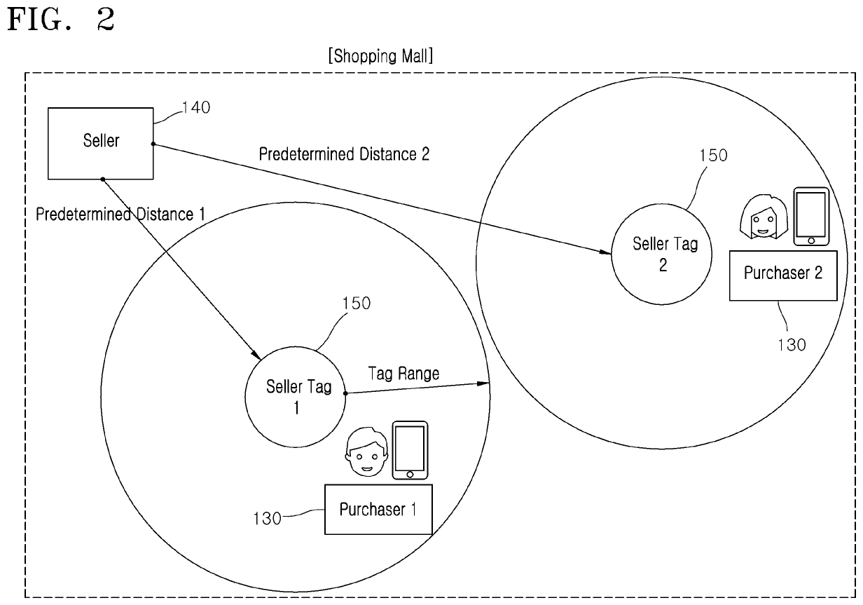

The communication unit 110 may transmit an estimated arrival time calculated using location information of the seller or the location information included in the order information to the seller 140. The estimated arrival time may be an estimated arrival time at which the single purchaser or the purchasers related to the group order information will arrive at the store of the seller. Location information of the single purchaser or the purchasers related to the group order information may be transmitted to the seller 140, or the estimated arrival time calculated using the location information may be transmitted to the seller 140. The server 100 for e-commerce ordering may calculate and transmit the estimated arrival time to the seller 140 or transmit the location information so that the seller 140 can use the location information to calculate the estimated arrival time. To remove the inefficiency of transmitting location information of all of the purchasers related to the group order information to the store, it is possible to transmit the location information of the single purchaser or the average location information of the purchasers to the store. The estimated arrival time based on the location information or a movement route to the store may be transmitted to the purchaser 130. When the purchaser has to visit a particular place for the product that the purchaser intends to purchase and it takes time for the seller to prepare the product, the location information is received from the purchaser 130, an estimated arrival time at which the purchaser 130 will arrive at the store of the seller is calculated using the received location information of the purchaser and transmitted to the seller, so that the seller may prepare the product by the estimated arrival time. Like in a restaurant, this is useful for a case in which it takes a time to prepare a product, and the product has to be prepared by an estimated arrival time. The location information of the purchaser may be calculated using global positioning system (GPS) information or a network identifier of the purchaser terminal, or a location of a base station communicating with the purchaser terminal and received when the purchaser recognizes a recognition tag, such as a beacon, a QR code, or an NFC code, installed at a predetermined distance from the store. For example, as shown in FIG. 2, beacon type recognition tags (defined herein as seller tags and electronically connected to an ordering server) may be installed at one or more locations separated predetermined distances from a seller store and, upon recognition of a purchaser terminal by each of the seller tags, location information of the purchaser terminal may be transmitted to the communication unit. Installation location information of each of the seller tags may be stored in a location analyzer 240 or a storage 230 described below. The received location information of the purchaser is recognized as location information of the purchasing group, and the estimated time at which the purchasing group will arrive at the store is calculated. The location information is acquired to calculate a moving speed, and the moving speed may be used to calculate the estimated arrival time.

The communication unit 110 may share the order information of the single purchaser and receive order information of other purchasers resulting from the shared order information. To this end, the communication unit 110 may transmit the order information of the single purchaser to other purchasers found with regard to the order information of the single purchaser and receive order information from the other purchasers. It is possible to provide information about whether other purchasers will make orders with reference to the information of the single purchaser and receive the order information from the other purchasers who have decided to make orders.

The processing unit 120 searches for the other purchasers related to the received order information and generates the group order information using the order information of the other purchasers and the order information of the single purchaser.

More specifically, to expand the order information of the single purchaser to group order information, the processing unit 120 searches for other purchasers who can generate group order information together with the single purchaser using the order information of the single purchaser. The processing unit 120 determines whether a purchaser identifier or an order identifier included in the order information of the single purchaser is an identifier corresponding to a group order. When the purchaser identifier is an identifier of a purchasing group, a personal identifier of a representative expanded to a purchasing group identifier, or an identifier of an individual included in the purchasing group, the processing unit 120 searches for other purchasers belonging to the purchasing group. When the order identifier is a group order identifier, an individual order identifier of a representative expanding to a group order identifier, or an identifier of an individual order included in the group order, the processing unit 120 searches for other purchasers related to the group order.

Using order information of the other purchasers found in this way and the order information of the single purchaser, group order information is generated. The group information is generated by adding to the order information of the single purchaser the order information of the other purchasers to be added. The group order information is order information of a group of one or more persons and thus can be order information of the single purchaser alone when other purchasers are not found. Also, when the order information of the single purchaser is a group order and there is no order information of other purchasers to be added, the order information of the single purchaser can be group order information.

Order information of each purchaser related to the group order information and benefits provided by the seller may be likewise provided to other purchasers related to the group order information. When a purchaser belonging to a particular purchasing group makes a group order, makes an individual order rather than a group order, or makes an order as a member of another purchasing group, the corresponding purchase information is provided to other purchasers belonging to the purchasing group, so that the purchase information may be shared. Also, benefits provided by the seller to a purchaser related to the group order information is likewise provided to other purchasers related to the group order information, so that the purchasers may share the benefits, the seller may obtain effects of an advertisement, and a server administrator may induce participation of many purchasers. When a purchaser does not want information sharing, it is possible to prevent sharing.

Payment for the group order information may be made by one or more of the purchasers related to the group order information or made by each of the purchasers related to the group order information. In the case of an existing group order, there is an inconvenience of having to make an entire payment at once. To solve this problem, payment of group order information can be made by each purchaser related to the group order information. While providing benefits through a group order, it is possible to be accommodative to purchasers by allowing freedom in ordering and payment. When some purchasers, such as a manager, have the right to make a payment for a group order, only the purchasers having the right may be allowed to make payment, or a purchaser may make payment of another purchaser.

A server for e-commerce ordering according to another exemplary embodiment of the present invention may include a communication unit which receives order information of a plurality of purchasers and transmits group order information to a seller and the purchasers related to the group order information and a processing unit which generates the single piece of group order information using order information of purchasers among the plurality of purchasers from whom the order information has been received satisfying a condition for making a group order.

More specifically, a purchaser that may not have made a purchase as a member of a group order at the beginning of the purchase may share the benefits of a group order by making the group order in the middle of the purchase process. Acquaintance relationships between a plurality of purchasers can be used to make a group order of the purchasers. Acquaintance relationships may be determined according to whether or not the condition for making a group order is satisfied. The condition for making a group order can be satisfied when there is a history of making a purchase with a group order, purchasers have registered each other's information, or purchasers have a common spatial or temporal characteristic for which individual orders may be recognized as one group order. The condition for making a group order is a condition on which purchasers can make a purchase as a group order and may be satisfied among purchasers who have a history of making a purchase with one group order or among purchasers who have received acquaintance information registered by the respective purchasers and registered themselves as each other's acquaintances. When purchasers have a history of making a purchase with the same group order, the purchasers are determined to have acquaintance relationships. Also, when order information is received, acquaintance information stored and registered in a purchaser terminal is received, and whether there is a purchaser whose information corresponds to information of other purchasers from which the order information has been received is determined, so that an ordering group can be formed. Alternatively, a search is enabled among purchasers, and a messenger service among purchaser terminals is provided, so that the purchasers can form a purchasing group.

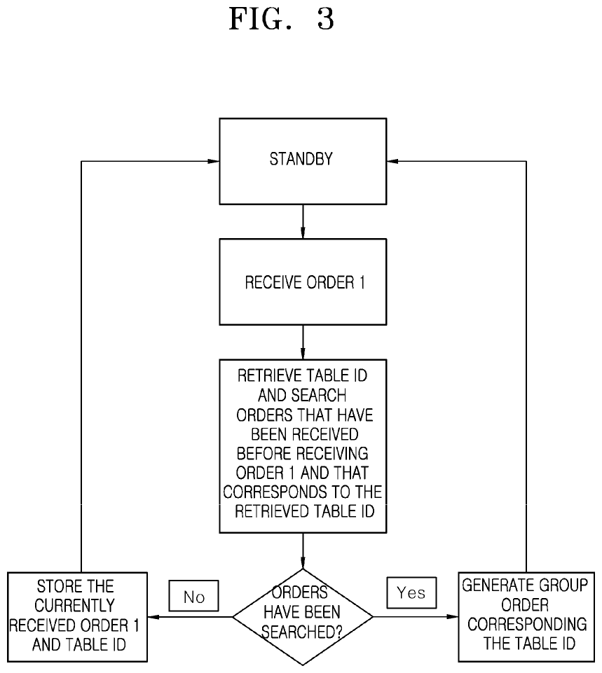

The condition for making a group order can be satisfied when the purchasers are located within a predetermined distance. One group order can be obtained from order information of purchasers who are within a range which can be determined as one ordering group, such as one table in a restaurant. By way of example, in a seller store (for example, a restaurant) provided with a plurality of tables, the ordering server may be operated to manage order information of purchasers classified according to the tables and stored in the storage according to table IDs allocated to the tables, respectively. When each of the purchasers inputs a certain table ID to a client application installed in a his or her terminal (that is, a data communication device), the table ID may be transmitted together with the order information to the ordering server through the client application and the ordering server may create one group order based on a plurality of pieces of order information having the same table ID. FIG. 3 shows a time series operation of the above configuration. Upon reception of the order information from the terminals of the purchasers in a standby state, the ordering server extracts the table ID from the received order information. Then, when order information having the same table ID as the extracted table ID is previously stored in the storage, the ordering server creates one group order based on the previously stored order information and the received order information, or when the order information having the same table ID as the extracted table ID is not previously stored in the storage, the ordering server stores the received order information in the storage together with the table ID received together with the order information. A group order may be created in a way of increasing the number of pieces of the order information included in the group order through repetition of the above process. Also, using location information of purchasers, it is possible to induce a group purchase for a suitable product at the corresponding location. If purchasers are in a space in which it is possible to know the locations of the purchasers or within a preset distance when the purchasers have allowed location tracking, it is possible to automatically determine whether or not the condition for making a group order is satisfied among the purchasers by a setting or a process in which a purchaser searches for a product or makes a purchase. When a purchaser who intends to purchase an identical or similar product is in a preset location, it is possible to create a purchasing group by connecting purchasers to each other. Alternatively, it is possible to create a purchasing group by connecting purchasers to each other who search for the same product.

Various pieces of information can be used to determine whether or not the condition for making a group order used to create a purchasing group is satisfied. It is possible to use location tracking based on the GPS or a base station, whether or not an input uniform resource locator (URL) is identical to a URL input by a purchaser, recognition of a physical pattern, including text, an image, a sound wave, etc., such as, a beacon, a QR code, an NFC code, etc., or an exchange or reception of a physical signal, including a radio wave of a device, a magnetic field, a ray of light, etc., and so on. Information obtained by recognizing a sound output from a store or by recognizing a phrase or an image in a store can be used. Among acquaintances who intend to form a purchasing group, various pieces of information, including information obtained by recognizing voices and image of the acquaintances, information obtained by exchanging and recognizing physical signals among acquaintance terminals, etc., can be used to determine whether or not the condition for making a group order is satisfied.

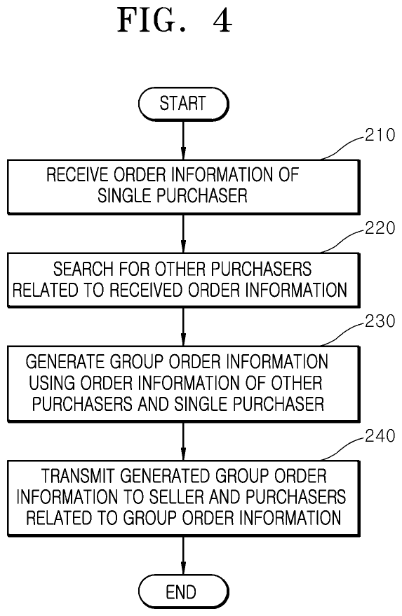

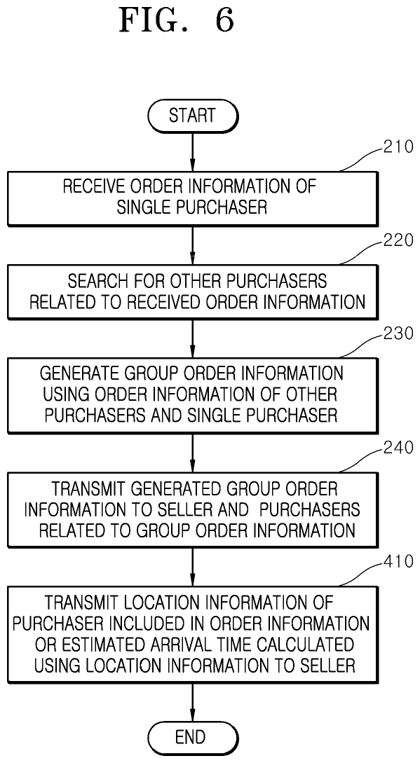

Each operation of FIGS. 4 to 7 corresponds to an element of the server 100 for e-commerce ordering shown in FIG. 1, and overlapping descriptions will be replaced by detailed descriptions of the server 100 for e-commerce ordering shown in FIG. 1.

FIG. 4 is a flowchart of a method for e-commerce ordering according to an exemplary embodiment of the present invention.

In operation 210, order information of a single purchaser is received.

More specifically, the order information may include one or more of a purchaser identifier, an order identifier, ordered product information, seller information, location information, and payment information. The order information can be received from the purchaser, a seller, or a seller tag.

When a terminal of the purchaser is connected to the seller tag, it is possible to receive the order information from the terminal of the purchaser or the seller tag.

In operation 220, other purchasers related to the received order information are searched.

More specifically, other purchasers who can generate group order information together with the single purchaser are searched using the order information of the single purchaser. Using the purchaser identifier or order identifier included in the order information of the single purchaser, it is possible to search for other purchasers who can generate group order information together with the single purchaser.

In operation 230, group order information is generated using order information of the other purchasers and the order information of the single purchaser.

More specifically, when there is order information of the other purchasers found using the order information of the single purchaser, group order information is generated by adding the order information of the other purchasers to the order information of the single purchaser.

In operation 240, the generated group order information is transmitted to the seller and the purchasers related to the group order information.

More specifically, the order is processed by transmitting the generated group order information to the seller, and the group order information is shared by transmitting the group order information to the purchasers related to the group order information. The group order information is transmitted to all of the other purchasers found in operation 220, so that the group order information can be shared.

Order information of each purchaser related to the group order information and benefits provided by the seller may be likewise provided to other purchasers related to the group order information. Payment for the group order information may be made by one or more of the purchasers related to the group order information or made by each of the purchasers related to the group order information.

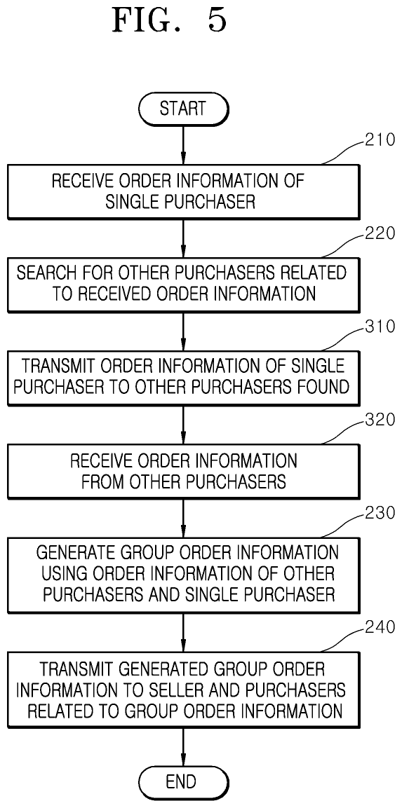

FIGS. 5 to 7 are flowcharts of methods for e-commerce ordering according to other exemplary embodiments of the present invention.

In operation 310, the order information of the single purchaser is transmitted to other purchasers found.

More specifically, when it is necessary to receive order information of the other purchasers to generate group order information, the order information of the single purchaser is transmitted to the other purchasers found in operation 220. After order information of the other purchasers is received, the order information of the single purchaser may not be transmitted to the found other purchasers.

In operation 320, order information is received from the other purchasers.

More specifically, the order information for a group order can be received from the purchasers who have received the order information of the single purchaser transmitted in operation 310. The order information of the other purchasers is used to generate group order information.

In operation 410, location information of a purchaser included in the order information or an estimated arrival time calculated using the location information is transmitted to the seller.

More specifically, the estimated arrival time is a time at which the single purchaser or the purchasers related to the group order information will arrive at a store of the seller.

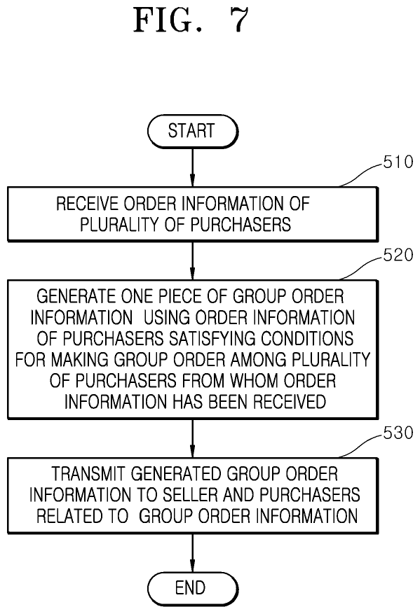

FIG. 7 is a flowchart of a method for e-commerce ordering according to another exemplary embodiment of the present invention.

In operation 510, order information of a plurality of purchasers is received.

More specifically, the order information of the plurality of purchasers is received. The order information of the plurality of purchasers may not include information for confirming a group order.

In operation 520, one piece of group order information is generated using order information of purchasers who satisfy a condition for making a group order among the plurality of purchasers whose order information has been received.

More specifically, one piece of group order information is generated using the order information of the purchasers who satisfy the condition for making a group order among the plurality of purchasers in the order information of the plurality of purchasers not including information for confirming a group order. The condition for making a group order can be satisfied when there is a history of making a purchase with one group order, purchasers have registered each other's information, or purchasers have a common spatial or temporal characteristic for which individual orders may be recognized as one group order. Also, the condition for making a group order can be satisfied when the purchasers are within a predetermined distance.

In operation 530, the generated group order information is transmitted to a seller and the purchasers related to the group order information.

A server for e-commerce ordering according to an exemplary embodiment of the present invention can be applied not only to industrial products but also to various services, such as a restaurant and a performing place, which can be ordered by a group of persons.

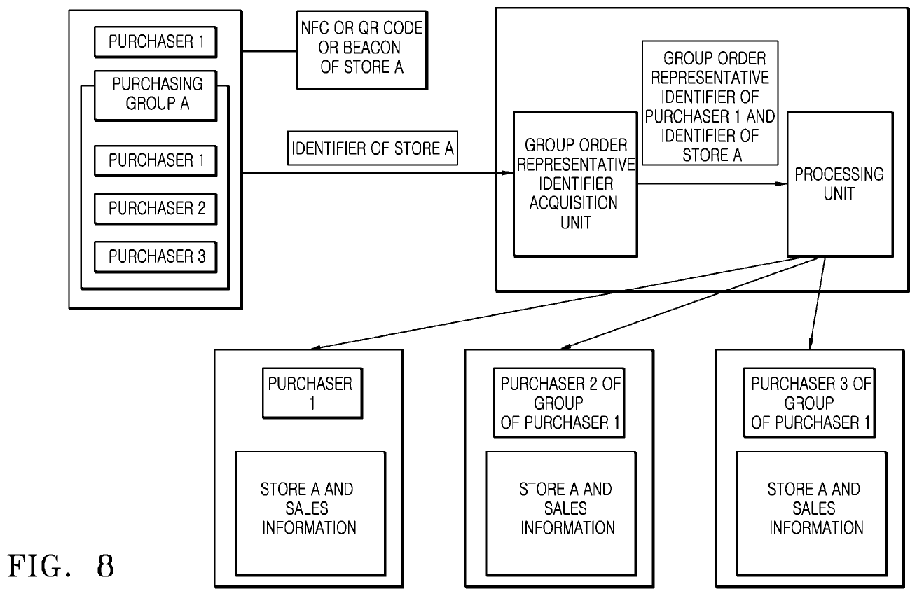

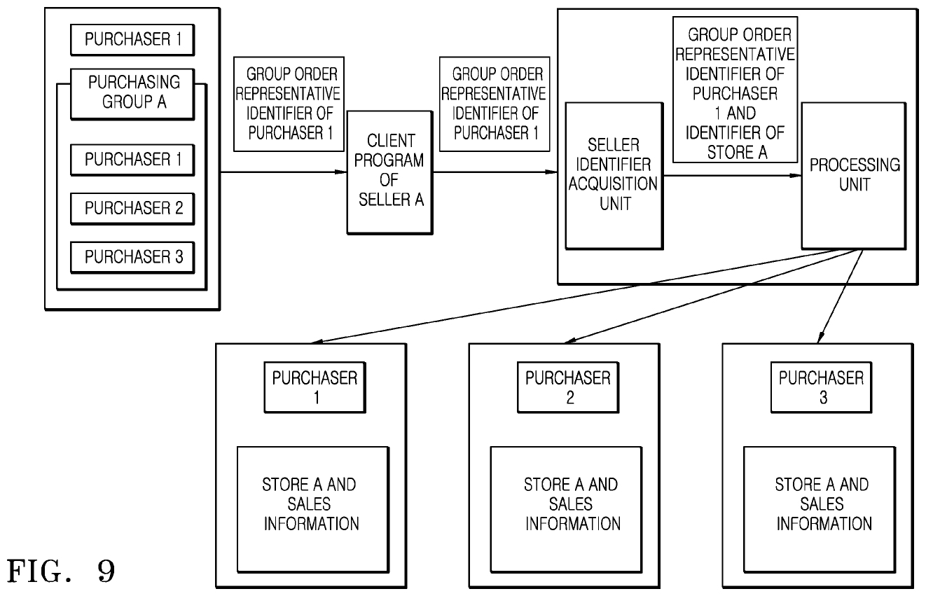

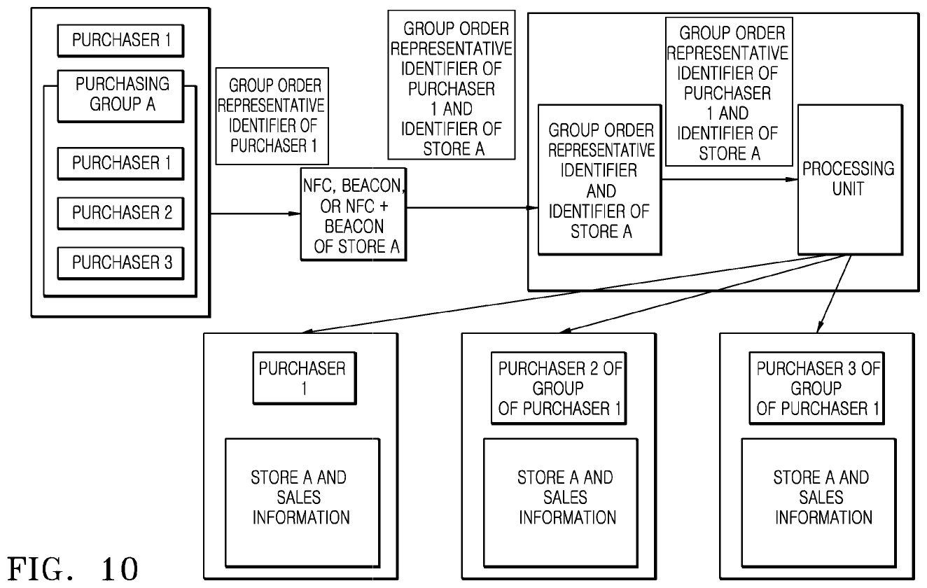

FIGS. 8 to 10 show processes in which methods for e-commerce ordering according to exemplary embodiments of the present invention are executed among purchasers, a server, and a seller.

A server for e-commerce ordering may include a communication unit and a processing unit and may further include a group order representative identifier acquisition unit, a seller identifier acquisition unit, or a group order representative identifier and seller identifier acquisition unit according to information acquired from information received through the communication unit for searching for other purchasers.

A terminal (a client program or a web site) of a wired or wireless online purchaser generates a purchasing group identifier or a group order identifier of a purchasing group consisting of one or more member. Using the generated group identifier and group order identifier, at least one of the purchasers transfers arrival at a sales spot through a seller client at the sales spot or transfers a distance and time from the sales spot to a server through which information can be transferred to the seller, so that the seller can process the group order or prepare to process the group order. Also, information on the seller is shown on terminals (client programs) of all the members of the purchasing group, so that each member can individually input his or her own order.

The method for e-commerce ordering can be performed as in the following examples.

A first example is a method of making a group order at a spot without making an order in advance. When one member of a group transfers a group identifier at a sales spot as a notification of arrival at the sales spot to the server through a seller client, the server recognizes the store and the group and shows information on the store in the purchaser clients of all members of the group. More specifically, when four persons are connected to each other in a purchaser group, and one of the four persons inputs a group identifier to a restaurant client application while the four persons are visiting a restaurant, the restaurant and the restaurant menu are shown through client applications of all of the four persons, so that orders can be made.

In a second example, when one of the four persons recognizes an NFC or QR code in a restaurant and sends the information to the server after the four persons arrive at the restaurant without making orders in advance like in the first example above, the server shows the restaurant and the restaurant menu through the client applications of all of the four persons, so that orders can be made.

A third example is a case of making orders in advance. When each of the four persons makes an individual order through his or her own purchaser client application and then arrives at the spot, one of the four persons inputs an order identifier or the group identifier to a seller client application, and the seller can confirm individual orders of the group. Alternatively, one person recognizes an NFC or QR code in the store and transmits the information to the server, and the seller can confirm whether or not the group has arrived and individual orders through a seller client.

A fourth example is a case of making an order in advance. When at least one of the four persons allows location tracking or recognizes an NFC or QR code whose location can be found by the seller or the server through his or her terminal and transmits the information to the server after each of the four persons makes an order, the seller can know arrival status of the corresponding group at the sales spot through a seller client. Specifically, when one of the four persons recognizes NFC and QR codes installed 100 m away from the restaurant through his or her terminal and transmits the information to the server, the server sends the information to the restaurant to which the group has made orders, so that the restaurant can prepare for the orders.

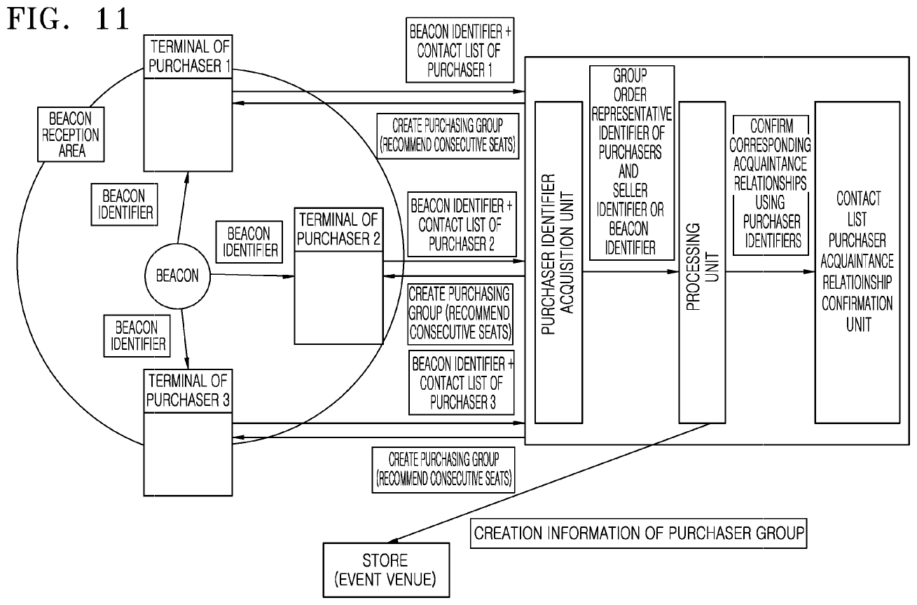

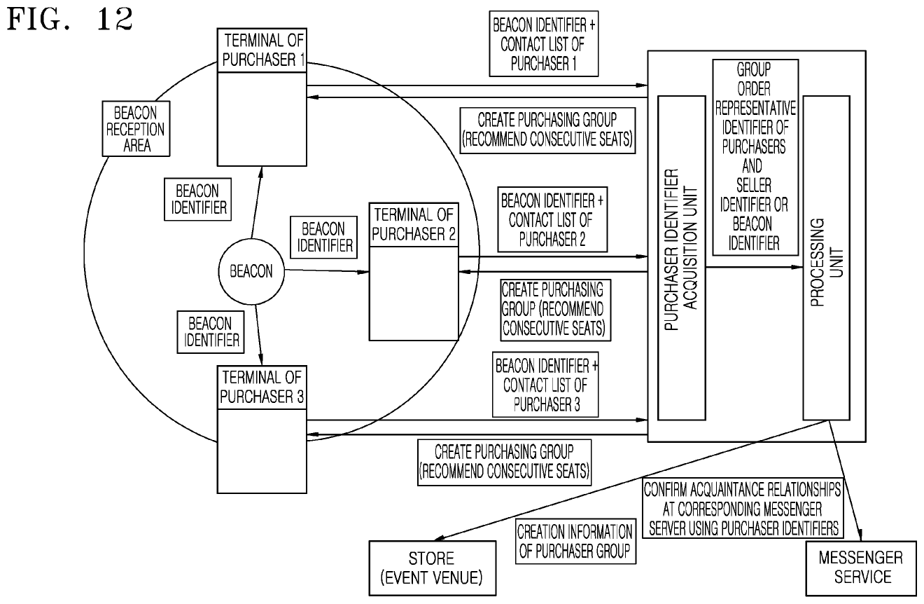

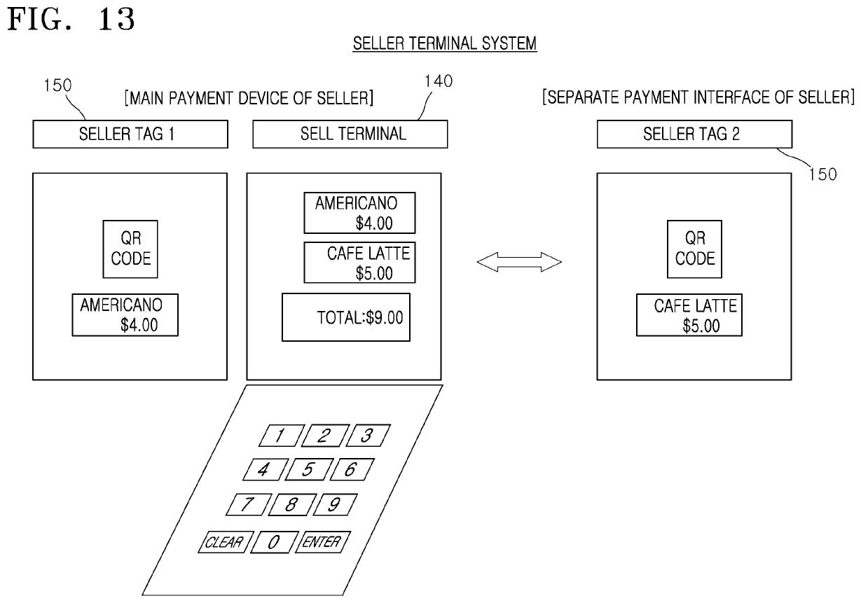

FIGS. 11 and 12 show processes in which relationships expand to a group of a plurality of purchasers in a method for e-commerce ordering according to an exemplary embodiment of the present invention.

A server for e-commerce ordering may include a communication unit and a processing unit and may further include a purchaser identifier acquisition unit to acquire information for searching for other purchasers from information received by the communication unit and a contact list purchaser acquaintance relationship confirmation unit for confirming acquaintance relationships between a plurality of purchasers to generate group order information.

When each of the purchasers selects stores (online and offline) or prepares for purchases and orders and starts to make purchases and orders at the same store, in the same service spot and space, or in a space in which the seller can know locations of the purchasers before connecting to a purchasing group, the server or a client program can find acquaintance relationships for using the same service from a server, a phone book database, or a contact list of a social network service (SNS) capable of communication, a messenger service, etc., and expand the relationships to a group of purchasers.

FIG. 13 to FIG. 15 show processes in which relationships expand to a group of a plurality of purchasers in a method for e-commerce ordering according to other exemplary embodiments of the present invention. The following exemplary embodiments shows examples of securing a history of common purchase proceeded in the past under conditions of expanding individual purchasers into a purchaser group.

In order to realize these embodiments, a seller store may be provided with a seller terminal system adapted to allow simultaneous individual payment by a plurality of purchasers, who visit the seller store and order products together, as shown in FIG. 13. The seller terminal system includes a main payment device, through which a seller inputs order information of each of the purchasers, and a plurality of seller tags (which may include an input device, such as a QR code scanner or a barcode scanner, and a display device, such as an LCD or a touch screen), which are connected to the main payment system to treat the individual order information of each of the purchasers (FIG. 13 shows an example in which the seller terminal system is provided with two seller tags (first and second seller tags). With this configuration, the seller terminal system allows the plurality of purchasers to perform individual ordering and payment at the same time and a purchaser group history is created as subordinate information in the course of allowing the plurality of purchasers to perform individual ordering and payment at the same time.

Specifically, referring to FIG. 14, when a seller inputs first and second order information of a first purchaser and a second purchaser to the main payment device, the first and second order information is output through the first and second seller tags, respectively, and first and second purchaser terminals of the first and second purchasers proceed with individual payment after requesting payment to a payment server upon reception of the first and second order information output through the first and second seller tags (in which the first and second purchaser terminals may receive the first and second order information upon tagging the first and second seller tags). In this process, the first and second purchaser terminals may allocate an identifier (for example, the same table ID), which indicates common purchase, to the first and second order information and transmit the first and second order information to a purchaser group creation unit 220 (described below) of the ordering server, and, upon receiving the order information of each of the first and second purchasers, the purchaser group creation unit 220 creates a purchaser group (or a temporary purchaser group) by determining that there is a history of common purchase by the first and second purchasers in the past, based on the common purchase identifier.

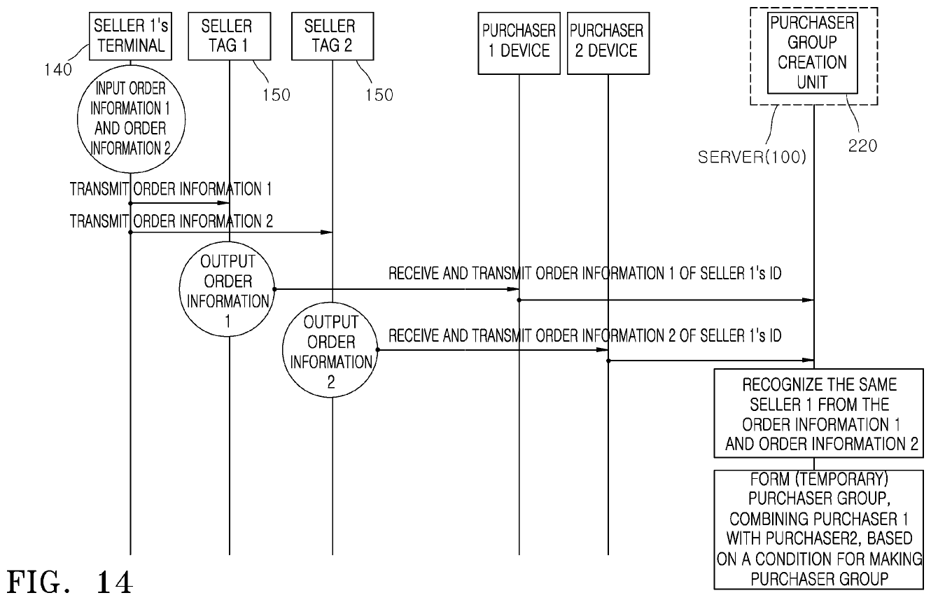

In another embodiment, referring to FIG. 15, when a seller inputs the first and second order information of the first and second purchasers to the main payment device, the main payment device may be operated to allocate the same group order ID to the first and second order information. The first and second order information is output through the first and second seller tags, respectively, and, when the first and second purchasers use the first and second purchaser terminals to tag the first and second seller tags based on the first and second order information output through first and second seller tags, respectively, identification information of the first and second purchasers is transmitted to the main payment device through the first and second seller tags, respectively, and the main payment device transmits the identification information and the order information of the first and second purchasers to a payment server (not shown) to allow individual payment of the first and second purchasers. In this process, the main payment device may transmit the order information and the identification information of the first purchaser and the order information and the identification information of the second purchaser to the purchaser group creation unit 220 (described below) together with the same group order ID and, upon receiving the order information of each of the first and second purchasers, the purchaser group creation unit 220 creates a purchaser group (or a temporary purchaser group) by determining that there is a history of common purchase by the first and second purchasers in the past, based on the same group order ID.

As a result, when the first and second purchasers purchase products or services at the same seller store, purchase history information thereof may be stored as a group order history in the ordering server and the main payment device may be operated to recommend the first and second purchasers as members of the temporary purchaser group by analyzing the first and second purchasers as members of a potential purchase group based on the group order history stored in the ordering server in response to further purchase activity of the first and second purchasers. The group order history may act as data providing information regarding close users or joint users required not only for group ordering and payment but also for prevention of epidemics and the like.

Relationship expansion to a group of purchasers can be used as described in the following examples.

First, when three acquaintances who have not been grouped yet using the present service start to make orders using the present service in the same restaurant, the server receives a restaurant identifier or restaurant table identifiers and identifiers of the individuals, and confirms whether or not the users have been registered as acquaintances in each other's phone books, notifying each user or a seller of the acquaintance relationships, leading to connections in a purchasing group, or creating a purchasing group.

Second, when three acquaintances select event seats or purchase event tickets around a beacon installed close to an event venue, a purchaser client confirms acquaintance relationships based on a beacon identifier and identifiers of the respective purchasers by communicating with messenger service, phone book database, contact list, and SNS servers directly or through the server for the present service, and creates a purchasing group. The server recognizes that the purchasing group consists of acquaintance relationships and provides adjacent seats.

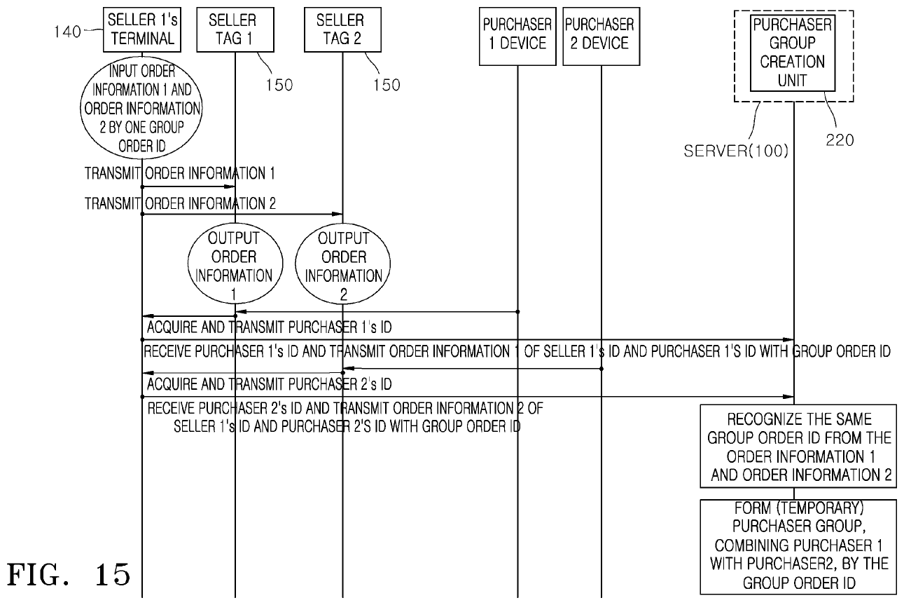

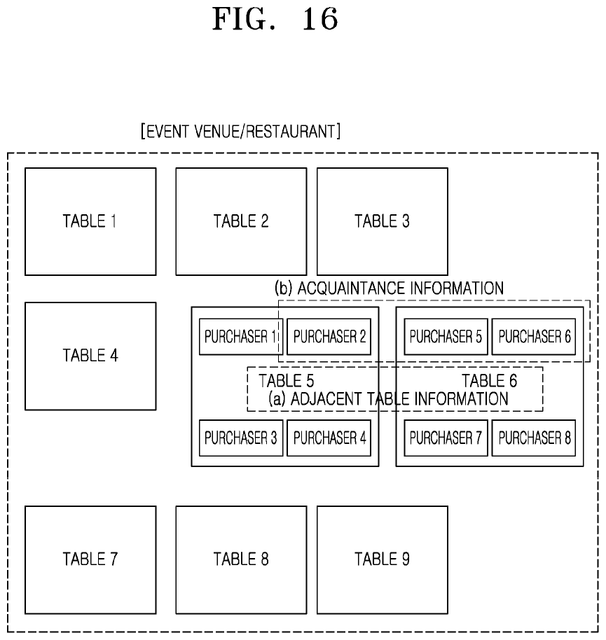

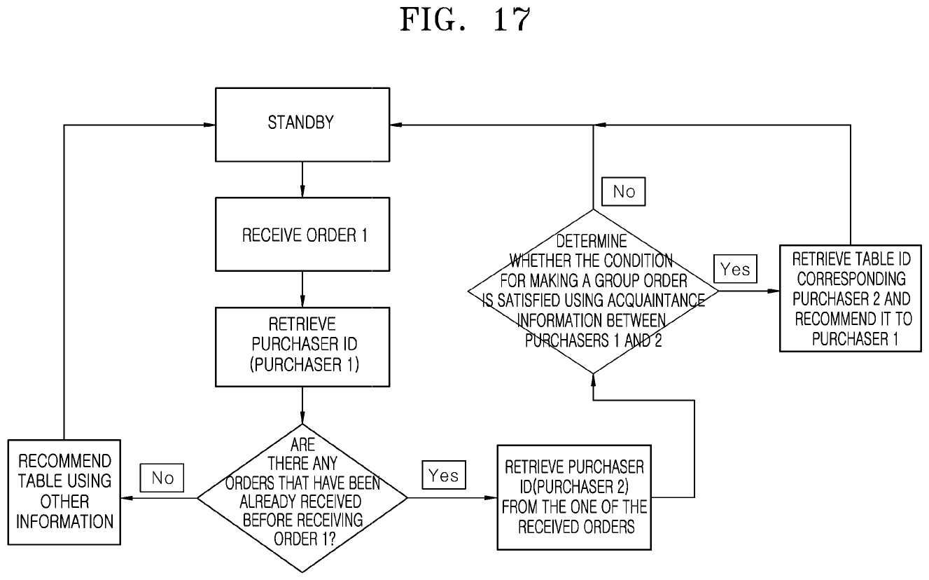

In addition, referring to FIG. 16, an exemplary embodiment wherein a purchaser group is created from a plurality of purchasers at a seller store (for example, a restaurant, an event hall, and the like) provided with a plurality of tables (in which a table ID is allocated to each table) will be described in detail. In this embodiment, with a second purchaser and a sixth purchaser seated on a fifth table and a sixth table, respectively, the server receives order information of the fifth purchaser. The server extracts order information of the second purchaser among previously received order information and determines whether conditions for creation of the purchaser group are satisfied based on acquaintance relationship information. When the acquaintance relationship between the second and fifth purchasers is ascertained, the server recommends the fifth table to the fifth purchaser based on a table ID of the fifth table at which the second purchaser sits. In order to ascertain suitability of sharing a table with other purchasers, the server repeats the above process. For example, upon ascertaining that there is an acquaintance relationship between the fifth purchaser and the sixth purchaser, the sixth table at which the sixth purchaser sits is also recommended together with the fifth table to the fifth purchaser. FIG. 17 is a time series flow of the above process.

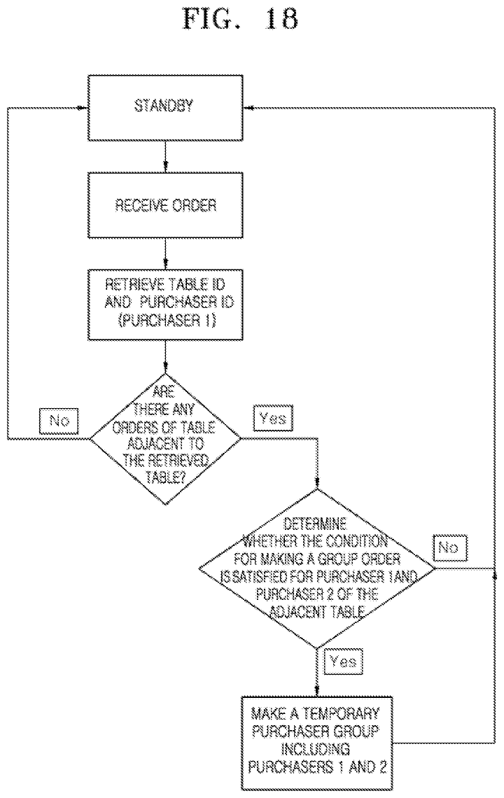

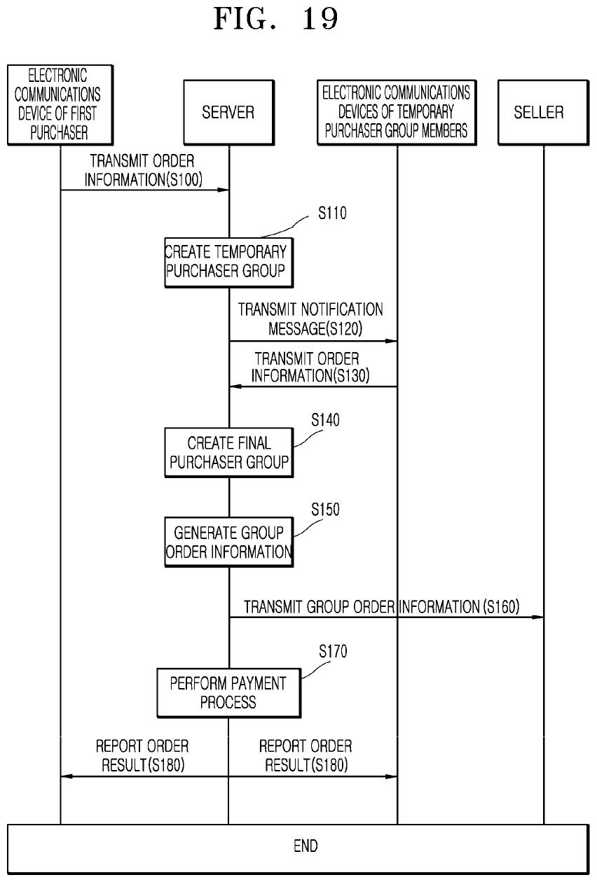

On the other hand, the plurality of purchasers may dividedly sit at the plurality of tables in the seller store and the server may create the purchaser group or the group order information based on close table information and acquaintance relationship information with respect to the purchases who dividedly sit at the plurality of tables. By way of example, referring to FIG. 16, first, with the order information of the fifth purchaser (including the table ID of the sixth table at which the fifth purchaser sits) received in the server, the server receives the order information of the second purchaser (including the table ID of the fifth table at which the second purchaser sits). The server extracts the table ID of the fifth table from the order information of the second purchaser and extracts the table ID of the sixth table near the fifth table based on table arrangement information (which may be previously stored in the server) in the seller store. The server searches for the order information corresponding to the table ID of the sixth table and ascertains the fifth purchaser who sits at the sixth table. The server creates a temporary purchaser group including the second purchaser and the fifth purchaser upon determining that the conditions for creation of the purchaser group are satisfied based on the acquaintance relationship information of the second purchaser and the fifth purchaser. Thereafter, the server receives the order information of the sixth purchaser (including the table ID of the sixth table at which the sixth purchaser sits) and extracts the table ID of the sixth table based on the received order information and the table ID of the fifth table near the sixth table based on the table arrangement information. The server searches for the order information corresponding to the table ID of the fifth table and ascertains the second purchaser who sits at the fifth table. The server creates a temporary purchaser group including the sixth purchaser and the second purchaser upon determining that the conditions for creation of the purchaser group are satisfied based on the acquaintance relationship information of the sixth purchaser and the second purchaser. As a result, the acquaintance relationship expands to the fifth purchaser and the sixth purchaser with reference to the second purchaser to allow creation of a temporary purchase including the second purchaser, the fifth purchaser and the sixth purchaser. FIG. 19 shows a time series flow of the above process.

Third, when three acquaintances have the intentions to make purchases at store A and the intentions are transferred to the server through a purchaser client program for the present service, the server communicates with a particular messenger server to find purchasers who have acquaintance relationships in the corresponding messenger service among purchasers who use store A, and creates a purchasing group for store A.

As can be seen from the above exemplary embodiments, the present invention has the following effects.

Acquaintances share an ordering process with one another in real time and thus can communicate to select one store.

Selecting a common store, etc. is facilitated with the help from the acquaintances, and an order process is simplified.

Since orders of connected acquaintances are not separately handled but are gathered into one order and transferred to a store's point of sales (POS) terminal, the store can efficiently process the orders, and only one of the purchasers needs to pay attention to reception of ordered products. Also, when a payment application, etc. is used, only one purchaser among several connected purchasers needs to go through a security authentication, and thus payment can be simplified.

A store can easily do a promotion of providing benefits to several purchasers visiting the store together, and so on.

An example in which individual orders of a plurality of purchasers are consolidated into one group order through an operation in which a plurality of purchasers form a purchaser group, an operation of sharing order information among the plurality of purchasers, an operation of generating group order information, etc. will be described in further detail below.

FIG. 19 is a sequence diagram showing an ordering method which is an exemplary embodiment of the present invention, and the ordering method includes an operation in which a server receives order information from an electronic communications device of a first purchaser (S100), an operation of forming a temporary purchaser group (S110), an operation of transmitting a notification message to members of the temporary purchaser group (S120), an operation of receiving order information from the members of the temporary purchaser group (S130), an operation of creating a final purchaser group (S140), an operation of generating group order information (S150), an operation of transmitting the group order information to a seller (S160), an operation of performing a payment process (S170), and an operation of reporting an order result to members of the final purchaser group (S180).

The order information may include one or more of a purchaser identifier, an order identifier, ordered product information, seller information, location information, payment information, a uniform resource identifier (URI), and a token.

Based on the order information of the first purchaser, the temporary purchaser group may consist of potential purchasers who are in a predetermined relationship with the first purchaser and can make a group order with the first purchaser. For example, persons who are within a predetermined distance from the first purchaser, have been registered in a contact list of an electronic communications device of the first purchaser, subscribe to the same social network as the first purchaser, or have had experiences with making a group order with the first purchaser can be members of the temporary purchaser group. Alternatively, persons who have acquaintance relationships and further satisfy an additional condition can be members of the temporary purchaser group. Furthermore, a person who is personally designated by the first purchaser can be included in the temporary purchaser group. Acquaintance information of the first purchaser may have been obtained by the server or may be that obtained previously from the current electronic communications device of the first purchaser.

The notification message denotes a message frame which may include a type of a product or service that the first purchaser intends to purchase, quantity, price, a condition for purchase, a store name and the location of the seller, and a payment method. A member of the temporary purchaser group who receives the notification message may peruse information included in the notification message, transmit a response message indicating an intention to make an order, and then transmit the order information. As the occasion demands, it is possible to omit the response message and directly transmit the order information.

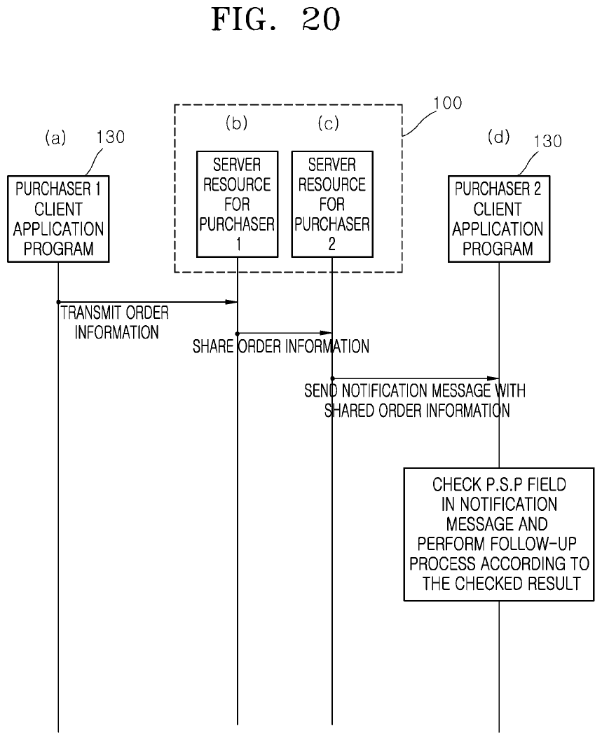

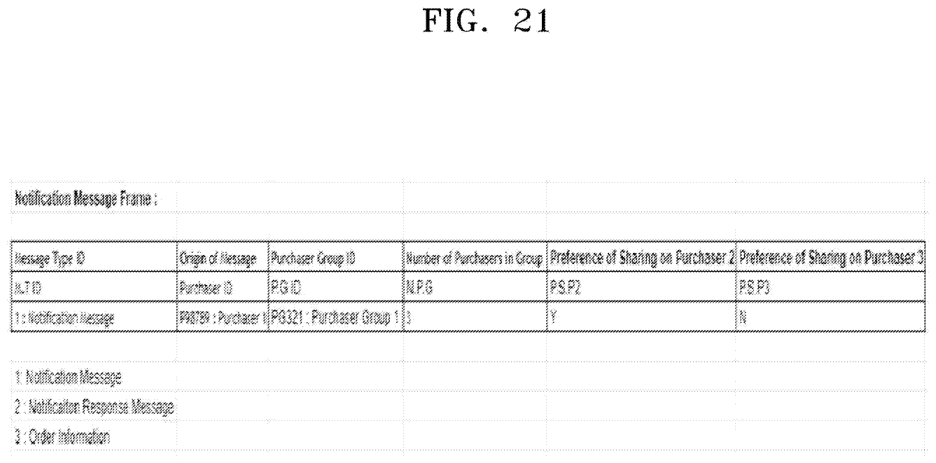

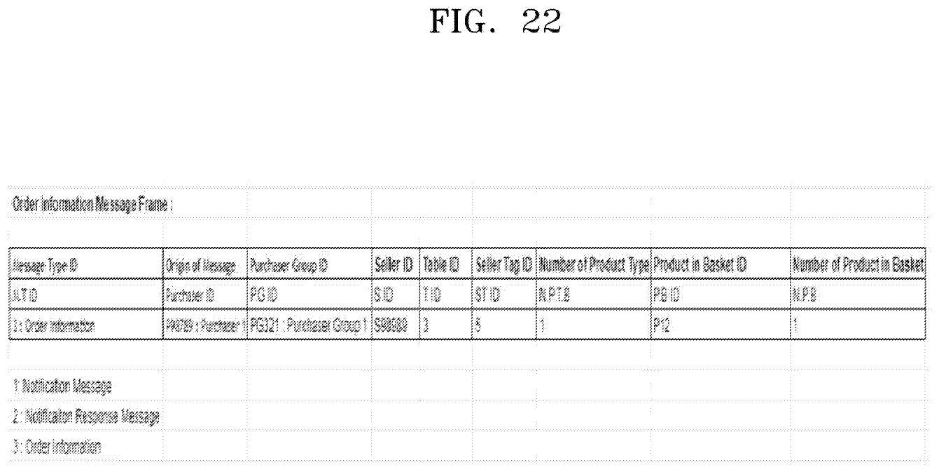

Meanwhile, the purchasers can prevent details of their orders from being shared among or being opened up to the purchaser group through the notification message. It is also possible to set the kind of information not to be opened up according to the purchaser. Referring to FIG. 20, an exemplary embodiment wherein details of orders of the purchasers are prevented from being shared among or being opened up to the purchaser group will be described in detail. In this embodiment, order information of the first purchaser may be shared with the second purchaser by transmitting the order information to a client application of the first purchaser terminal, a first memory resource region of the ordering server (that is, a memory resource region allocated for storage of the order information of the first purchaser in a memory (the storage 230 described below) region of the ordering server), a second memory resource region of the ordering server (that is, a memory resource region allocated for storage of order information of the second purchaser in the memory region of the ordering server), and a client application of the second purchaser terminal, in which information transmitted from the ordering server to the client application of the second purchaser terminal may include the order information of the first purchaser (configured to have a message frame as shown in FIG. 22) and a notification message functioning as attribute information (meta information) regarding the order information of the first purchaser. FIG. 20 shows an example of locations at which the order information of the first purchaser can be shared or blocked. When the first purchaser sets the client application of the first purchaser terminal to share their order information with the second purchaser or to prevent their order information from being opened up to the second purchaser, the setting information may be stored, based on the client application of the first purchaser terminal, in i) the memory of the first purchaser terminal, ii) the first memory resource region thereof, iii) the second memory resource region thereof, or iv) the client application of the second purchaser terminal or the memory of the second purchaser terminal through the client application (process iv may be carried out by a service server providing the client application). In addition, a value of the setting information is set in the PSP_#N (Preference of Sharing on Purchaser N) (N=2, 3, 4 . . . ) field among message frames of the notification message. Thereafter, whenever the order information of the first purchaser is created, the order information of the first purchaser is finally shared with the second purchaser or prevented from being opened up to the second purchaser depending upon the value of the setting information (that is, sharing or blocking) stored as described above.

By way of specific example, when the first purchaser sets the client application of the first purchaser terminal to prevent their order information from being opened up to the second purchaser, the setting information is stored in the first memory resource region and/or the second memory resource region (process ii and/or process iii). The ordering server ascertains the value of the setting information, that is, ‘N’ (Not Open Up), stored in the first memory resource region and/or the second memory resource region and does not transmit the notification message and/or the order information of the first purchaser to the client application of the second purchaser terminal.

As another example, when the setting information set to ‘N’ (Not Open Up) by the first purchaser is stored in the client application of the second purchaser terminal or in the memory of the second purchaser terminal through process iv), the notification message and the order information of the first purchaser may be transmitted from the ordering server to the client application of the second purchaser terminal and the client application of the second purchaser terminal may prevent the order information of the first purchaser received from the ordering server from being opened up to the second purchaser through ascertainment of the value of the setting information stored in process iv (in this case, the client application of the second purchaser terminal may prevent the order information of the first purchaser from being opened up to the second purchaser by ascertaining ‘N’, which is the value of the PSP2 field in the notification message).

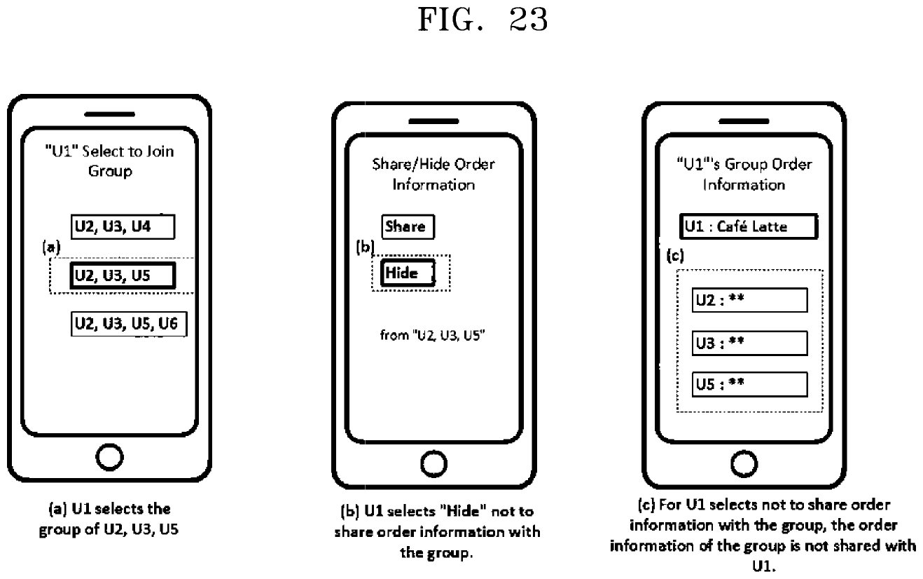

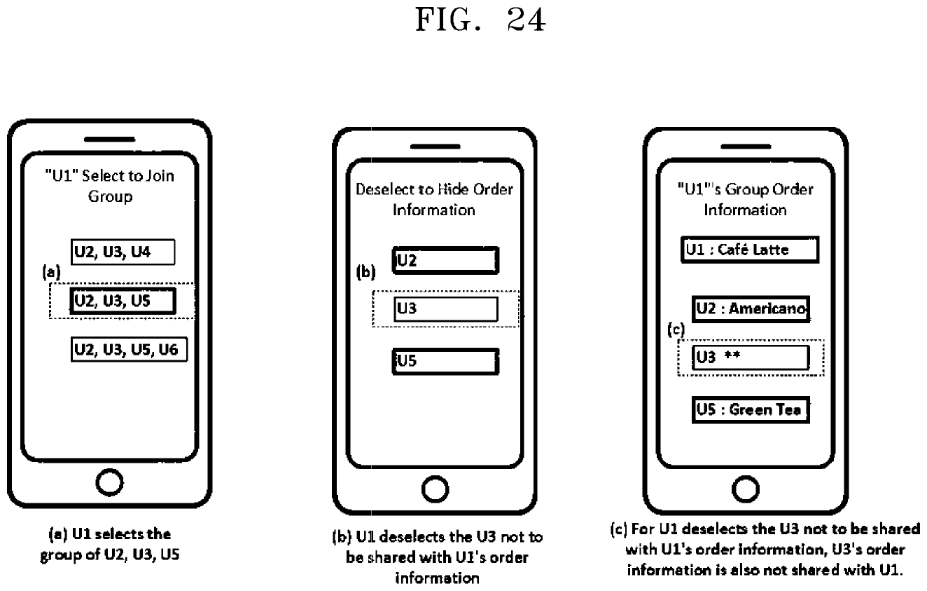

FIG. 23 and FIG. 24 show an example of a process in which a first purchaser sets sharing or hiding of their order information. A first purchaser U1 may select to join a purchaser group consisting of a second purchaser U2, a third purchaser U3 and a fifth purchaser U5 among three purchaser groups (FIG. 23(a)) and may set sharing or hiding of their order information with respect to the other purchasers (that is, U2, U3 and U5) (FIG. 23(b)). When the first purchaser sets their order information from being opened up to the other purchasers, order information of the other purchasers may be prevented from being opened up to the first purchaser (FIG. 23(c)). Alternatively, as shown in FIG. 24, the first purchaser U1 may select to join the purchaser group consisting of the second purchaser U2, the third purchaser U3 and the fifth purchaser U5 among three purchaser groups (FIG. 24(a)) and may set hiding of their order information with respect to a certain purchaser U3 (FIG. 24(b)). In this case, the order information of the second and fifth purchasers (U2, U5) may be opened up to the first purchaser and the order information of the third purchaser may be prevented from being opened up to the second purchaser (FIG. 24(c)).

The members of the final purchaser group includes, as members, persons who want a group order and thus have transmitted a response message in response to the notification message or have transmitted order information among the members of the temporary purchaser group. Alternatively, persons who further satisfy an additional condition, such as a distance from the first purchaser, etc., can become members. The first purchaser may not be included as a member, and the number of members may be one or more. To rapidly proceed with a purchase, members of the temporary purchaser group who do not transmit order information by a predetermined point in time can be excluded from the final purchaser group. Also, the final purchaser group can be determined by accepting a group purchaser participation request.

Meanwhile, the server may provide a purchaser group formation method using the URI shared among purchasers. By having purchasers input the corresponding URI through their electronic communications devices, it is possible to receive a purchaser group inquiry or a group participation request.

Also, a token for confirming that it is possible to form a purchaser group can be used to create a purchaser group. The server can provide a means of receiving a token value for forming or participating in a purchaser group through electronic communications devices of purchasers and involving only purchasers who have input a valid token value.

It is not necessary that all or some of the members of the temporary purchaser group order the same kind of products or services and can purchase as many as needed of all products or services on sale by the same seller using the information included in the notification message.

The notification message can be transmitted when the members of the temporary or final purchaser group issue orders to or purchases at different stores in a store determination operation or a store order transmitting operation. For example, the notification message can be transmitted when members of a purchaser group arrive at different stores, members of a purchaser group make orders at different stores, one of purchaser group members makes payment to a store different from a store at which another member among the purchaser group members has arrived, several purchasers simultaneously attempt to order or pay for one product while one of the purchaser group members can pay for a product that another member among the purchaser group members intends to order, orders or payment for seller sites, products, categories, or brands to which different URIs have been given, or a preset product quantity, order amount, etc. is exceeded.

A seller may present different conditions for a purchase according to purchase quantity. Therefore, the server can transmit a condition for purchase and a current state of purchase in real time to persons who have transmitted order information every time the order information is received.

The group order information is generated by consolidating separate order information received from the members of the final purchaser group and may include order identifiers, ordered product information, and time information related to preparation of ordered products. The order identifiers, the ordered product information, and the time information related to preparation of the ordered products included in the group order information may be used by the seller to prepare the ordered products so that at least one member of the final purchaser group can be provided with the ordered products at a sales spot. The at least one member who receives the ordered products at the sales spot can be selected by various ways as needed including being set to the first purchaser by default, being automatically set to a member who is closest to the sales spot among the members of the final purchaser group, and so on.

When a predetermined time elapses after the group order information is generated, the server can automatically transmit the generated group order information to the seller. Alternatively, when a final order confirmation message is received from a representative purchaser selected from among the members of the final purchaser group, the server can transmit the group order information to the seller. The representative purchaser may be the person who receives the products at the sales spot or different from a person.

Even after the group order information is received by the seller, a purchaser can transmit to the server a message for cancelling his or her order. When the server receives the order cancellation message, the server can transfer the information to the members of the purchaser group involved in the group order through a notification message.

When it is necessary to cancel all or some orders included in the group order information after the group order information is received by the seller, the server can transmit an order cancellation code directly to purchasers who intend to cancel the orders, or the server can transmit the order cancellation code to the seller first and then the seller can transfer the received order cancellation code to the purchasers. The purchasers receiving the order cancellation code can cancel or change their orders using the order cancellation code through their electronic communications devices. The order cancellation code may include all or some of the original group order information.

Besides a general meaning which indicates a person or a store selling products or services, the term “seller” includes the meaning of a device or system having a communications function managed by a salesman as an object for exchanging information with the server. In some cases, the seller may manage the server. In this case, the operation in which the server transmits the group order information to the seller can be replaced with an operation of sending the group order information to a module provided in the server to receive and process the group order information.

The group order information can be transmitted from the representative purchaser to the seller before or after payment of the purchaser group members. When the transmission of the group order information is performed after payment, it is possible to transmit a consolidated payment result of the purchaser group from the representative purchaser to the seller.

The seller can determine whether or not to accept orders with regard to the received group order information. For example, when an unacceptable order is included in the group order information, it is necessary to accept the group order information excluding the unacceptable order.

The seller can determine orders finally accepted by the seller by transferring a message including acceptable order information to all or some of the members of the purchaser group or the representative purchaser. Each purchaser belonging to the purchaser group can complete payment through his or her electronic communications device based on the accepted orders received from the seller.

In the method shown in FIG. 19, a temporary purchaser group is created after order information is received from the first purchaser. However, even when the first purchaser merely logs into a homepage of a store which sells a particular product or provides a service or merely logs into an application program such as an application installed in a smart phone, persons designated by the first purchaser in advance can be included in a temporary purchaser group, or the server can automatically select persons to be included in a temporary purchaser group and create a temporary purchaser group. When a temporary purchaser group is created in this way before order information is received from the first purchaser, the server can perform operation S100, skip operation S110, and then perform operation S120 in the method shown in FIG. 19. Meanwhile, when it is possible to create a temporary purchaser group by merely logging into an application program as mentioned above, logged-in acquaintance users who have arrived at the same store or are on the same way to the store can be immediately connected based on analysis of group purchase history data, and it is possible to recommend a store and a product suitable for a purchaser characteristic of an acquaintance group. When a pattern of purchases made by purchaser A together with purchaser B and a pattern of purchases made by purchaser A together with purchaser C are generated with regard to purchaser A, the two patterns may have a statistically significant difference. In this case, different stores and products can be recommended according to whether purchaser A is connected to purchaser B or purchaser C. When a purchaser visits different stores according to acquaintance purchasers who make a purchase together, the accuracy of a recommendation can be improved compared to a recommendation based on a purchase pattern generated from a purchase history of the single purchaser. Specifically, tracking a group purchase history of purchaser A may result in a pattern and similarity in which purchaser A frequently uses a coffee shop together with purchaser B and a pattern and similarity in which purchaser A frequently uses a restaurant together with purchaser C. In this case, when purchaser A is connected to purchaser B, a nearby coffee shop is recommended, and further, a coffee shop preferred by both the purchasers is indicated in real time in a purchase operation, so that a process of selecting a coffee shop can be facilitated.

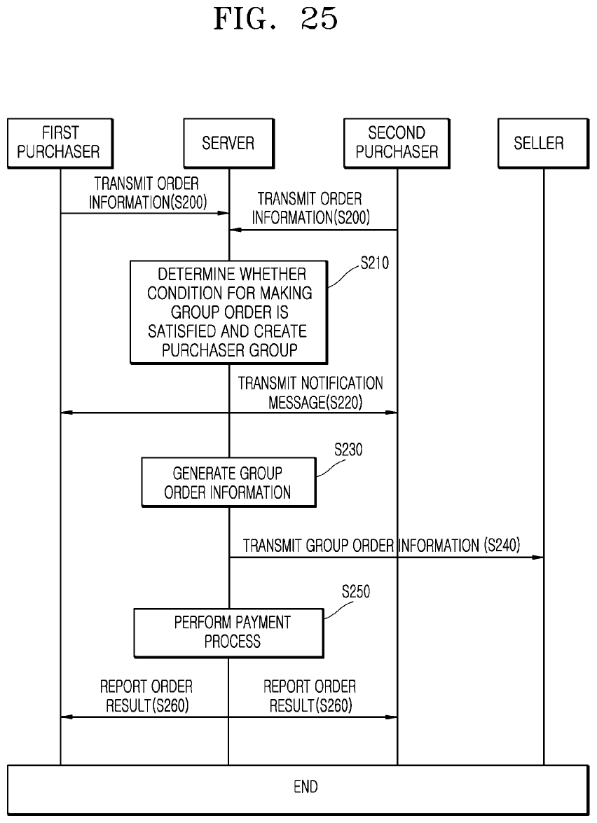

FIG. 25 is a sequence diagram showing an ordering method which is an exemplary embodiment of the present invention, and the ordering method includes an operation in which a server receives order information from a plurality of purchasers (S200), an operation of creating a purchaser group with purchasers satisfying a condition for making a group order using the received order information (S210), an order notifying operation of notifying the plurality of purchasers other than a purchaser of information related to an order of the purchaser through a notification message (S220), an operation of generating group order information (S230), an operation of transmitting the group order information to a seller (S240), an operation of performing a payment process (S250), and an operation of reporting an order result to the members of the purchaser group (S260).

The condition for making a group order may be satisfied when the corresponding purchaser is within a predetermined distance from the seller, purchasers have been registered in contact lists of each other's electronic communications devices, purchasers subscribe to an identical social network, or purchasers have had experiences making a group order together.

According to a detailed method of forming a purchaser group, it is possible to transmit a condition for purchase and a current state of purchase to the members of the purchaser group in real time every time order information is received.

During creation of a purchase group, a difference in reception time between a first piece of order information and a last piece of order information can be made to be within a predetermined time range for making rapid purchases.

The group order information may include order identifiers, ordered product information, and time information related to preparation of ordered products, and the order identifiers, the ordered product information, and the time information related to preparation of the ordered products may be used by the seller to prepare the ordered products so that at least one member of the purchaser group can be provided with the ordered products at a sales spot.

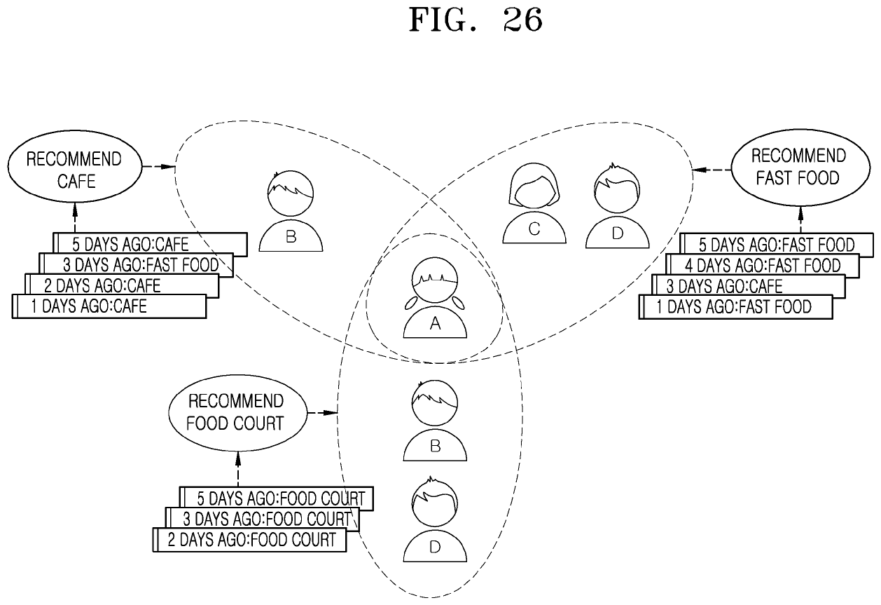

In the method shown in FIG. 25, a purchaser group is created after order information is received from purchasers. However, even when each of the purchasers merely logs into a homepage of a company which sells a particular product or provides a service or merely log into an application program such as an application installed on a smart phone, the server can automatically select persons to be included in a purchaser group and create a purchaser group under a particular condition. Meanwhile, when it is possible to create a purchaser group by merely logging into an application program as mentioned above, logged-in acquaintance users who have arrived at the same store or are on the way to the same store can be immediately connected based on an analysis of group purchase history data, and it is possible to recommend a store and a product suitable for the purchaser characteristic of an acquaintance group. When a pattern of purchases made by purchaser A together with purchaser B and a pattern of purchases made by purchaser A together with purchaser C are generated with regard to purchaser A, the two patterns may have a statistically significant difference. In this case, different stores and products can be recommended according to whether purchaser A is connected to purchaser B or purchaser C. When a purchaser visits different stores according to acquaintance purchasers who make a purchase together, the accuracy of a recommendation can be improved compared to a recommendation based on a purchase pattern generated from a purchase history of the single purchaser. Specifically, tracking a group purchase history of purchaser A may result in a pattern and similarity in which purchaser A frequently uses a coffee shop together with purchaser B and a pattern and similarity in which purchaser A frequently uses a restaurant together with purchaser C. In this case, when purchaser A is connected to purchaser B, a nearby coffee shop is recommended, and further, a coffee shop preferred by both of the purchasers is indicated in real time during a purchase operation, so that a process of selecting a coffee shop can be facilitated. FIG. 26 shows an example of recommendation of other stores depending upon purchasers.

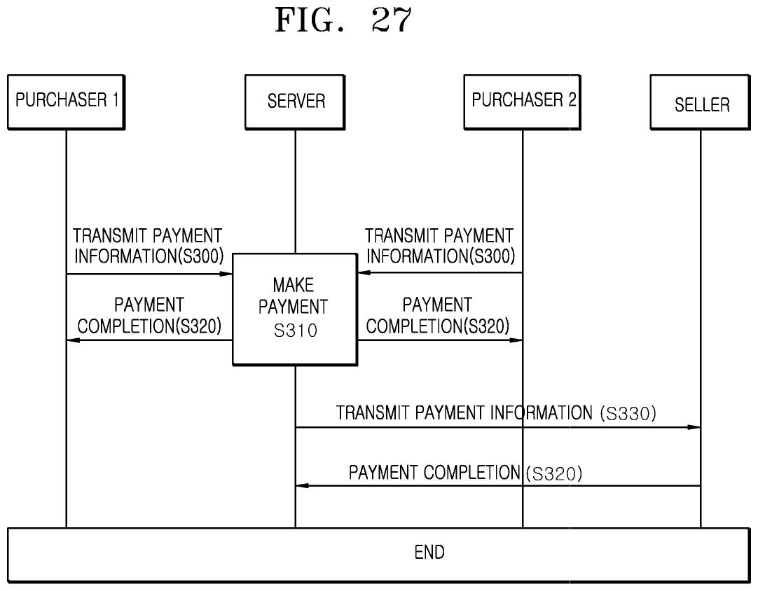

FIG. 27 is a sequence diagram showing a payment process of an indirect payment method, which includes an operation in which a server receives payment information from purchasers (S300), an operation of making payment between each purchaser and the server (S310), an operation of transmitting a payment completion message to the respective purchasers (S320), an operation of transmitting payment information to a seller (S330), and an operation of receiving a payment completion report from the seller (S340).

The indirect payment method denotes a method in which each purchaser makes a payment to the server and then the server makes payment to the seller. Therefore, according to the indirect payment method, it is the server that charges the purchaser.

The operation of making payment between each purchaser and the server (S310) may be performed every time each purchaser transmits payment information or after payment information is received from all purchasers involved in a group order.

When an incentive for orders made by the purchasers is provided by the seller, the incentive may be distributed to the purchasers by the server under predetermined rules. For example, if the seller provides a cash-back only when a particular purchase quantity is satisfied through the group order, the seller can provide the cash-back to the server upon satisfaction of the corresponding condition, and the server can distribute the cash-back received from the seller to the purchasers.

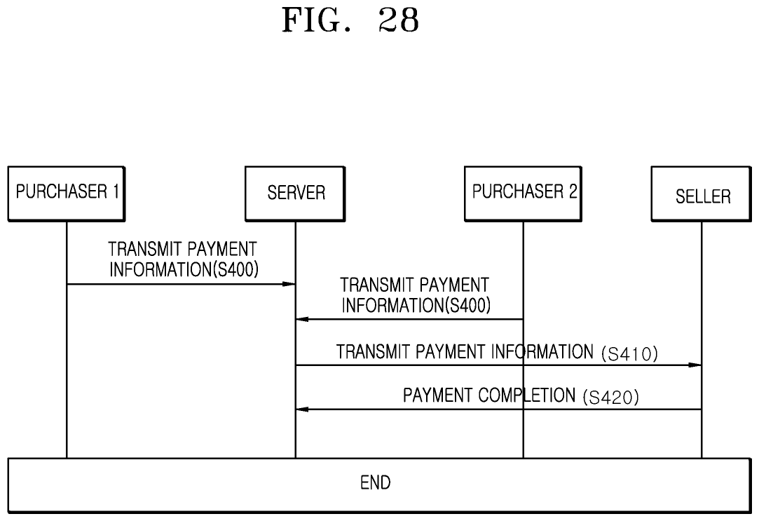

FIG. 28 is a sequence diagram showing a payment process of a direct payment method, which includes an operation in which a server receives payment information from purchasers (S400), an operation of transmitting the received payment information to a seller (S410), and an operation of receiving a payment completion report from the seller (S420).

The direct payment method denotes a method in which the server only functions to obtain payment information of purchasers and transfer the obtained payment information to the seller, and actual payment is made between each purchaser and the seller. Therefore, according to the direct payment method, it is the seller that charges the purchaser.

According to the indirect payment method or the direct payment method, when members of a final purchaser group (or a purchaser group) make a payment for orders, each member can make not only make separate payments but also collective payment with other members. A member of the final purchaser group (or the purchaser group) can transmit an additional message including information on the aforementioned payment method to the server or include the message in order information transmitted to the server.

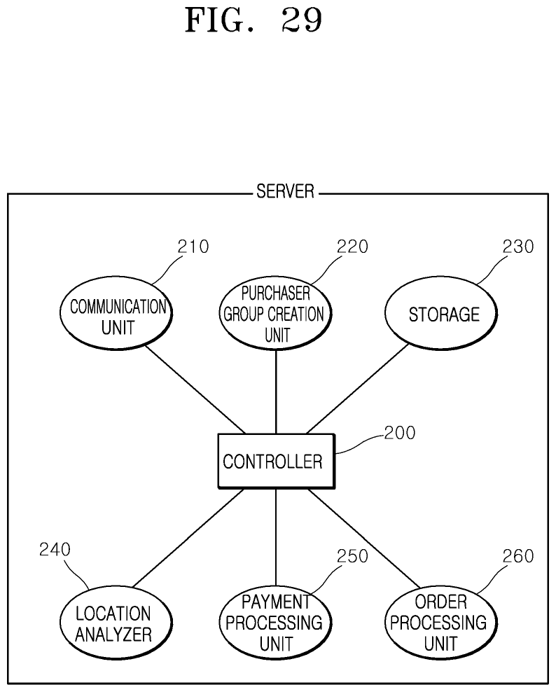

FIG. 29 is a diagram showing a configuration of a server which consolidates orders of purchasers into a group order. The server includes a controller 200, a communication unit 210, a purchaser group creation unit 220, a storage 230, and an order processing unit 260 and may further include a location analyzer 240 and a payment processing unit 250.

The communication unit 210 performs a communication between the server and an external electronic communications device.

The purchaser group creation unit 220 creates a purchaser group using order information received from purchasers. A single purchaser group or a plurality of purchaser groups may be created according to the progress of a purchase process or a particular condition related to purchasers.

The storage 230 stores information related to members of the at least one purchaser group.

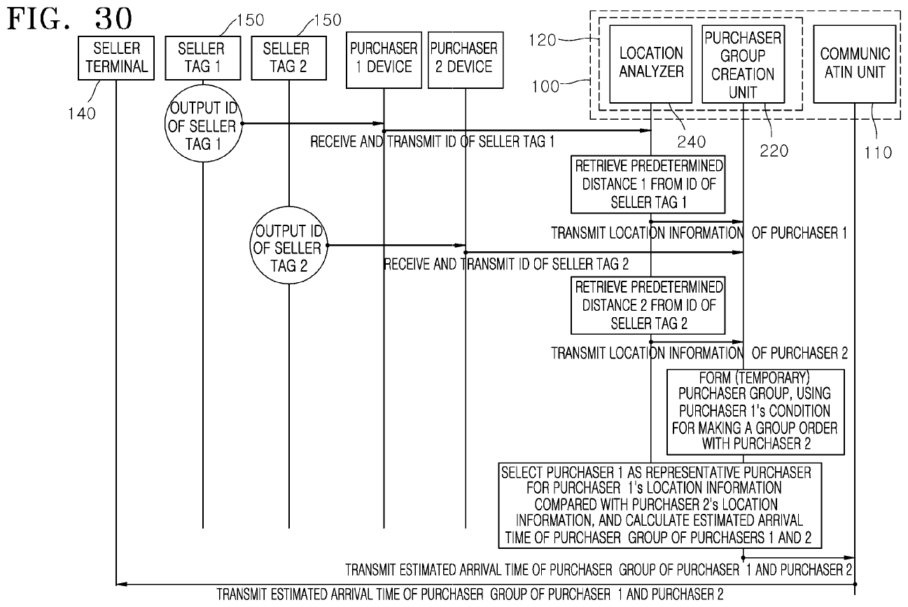

The location analyzer 240 analyzes locations of the members of the at least one purchaser group. Analyzed locations information can be used to analyze the time needed for a representative purchaser selected from among the members of the purchaser group to arrive at a seller. By way of example, for the seller tags described in FIG. 2, operation of the location analyzer 240 and the purchaser group creation unit 220 will be described in detail with reference to FIG. 30. Assuming that the first seller tag is installed at a location separated a first predetermined distance from a seller store and the second seller tag is installed at a location separated a second predetermined distance greater than the first predetermined distance therefrom, when the first purchaser terminal of the first purchaser and the second purchaser terminal of the second purchaser are recognized by the first seller tag and the second seller tag, respectively (or when the first and second purchasers use their terminals to tag on the first and second seller tags based on NFC or QR tagging, respectively), the location analyzer 240 may receive a tag ID of each of the first and second seller tags from the first and second seller tags or from the first and second purchaser terminals and may extract the first and second predetermined distances from the storage 230 based on the received IDs to transmit the first and second predetermined distances to the purchaser group creation unit 220. When a purchase group including the first and the second purchasers is not created currently, the purchaser group creation unit 220 may create the purchase group (or temporary purchase group) including the first and the second purchasers based on current location information of the first and second purchasers.

When the purchase group is created as described above, the first purchaser (that is, the first purchaser terminal) recognized by the first seller tag installed at a closer location to the seller store may be chosen as a representative purchaser and location information of the representative purchaser or an estimated arrival time calculated based on the location information may be transmitted to the purchaser terminal.

The payment processing unit 250 processes payment between the members of the at least one purchaser group and the server and payment between the server and the seller.

The order processing unit 260 generates group order information by consolidating order information received from the members of the at least one purchaser group.

The controller 200 collectively controls the communication unit 210, the purchaser group creation unit 220, the storage 230, the location analyzer 240, the payment processing unit 250, and the order processing unit 260.

The present invention fuses two types of online communication, that is, a social network for daily-life sharing and communication among acquaintances and social commerce for providing benefits, etc. to purchasers who purchase products and services through group orders and allows use of a social network to which individuals belong or creation of a network for purchase at a service spot, thereby allowing members of the network to make group purchases and payments and share purchase experiences. Also, even when a group purchase is made, a separate payment function is provided for a service and product to be used by each individual to avoid inconvenience of group payment, and benefits which can be received from a seller according to a condition for purchase are shared as is within the social network group. Furthermore, a method for the network members to extend the benefits to another network is provided, thus providing the seller with an effective means of promotion a sales business and offered sales items.

According to the present invention, orders of a plurality of purchasers for products or services on sale by a particular seller are consolidated into one group order to make a purchase, and thus, when a seller provides an incentive according to a condition for purchase, the purchasers involved in the purchase can obtain benefits of the incentive.

The present invention collectively processes orders of purchasers belonging to a particular group, thereby enabling the purchasers of the particular group to simultaneously receive products or services.

According to the present invention, when a purchaser personally receives a product or service at a sales spot, a plurality of purchasers can request proxy purchases and deliveries by a representative purchaser without explaining orders of the respective purchasers one by one.

An apparatus according to the present invention may include a processor, a memory storing and executing program data, a permanent storage, a communication port for communicating with an external device, a user interface device, such as a touch panel, keys, etc., and so on. Methods embodied as a software module or an algorithm may be stored in a computer-readable recording medium as computer-readable codes or program instructions executable by the processor. The computer-readable recording medium is distributed over computer systems connected through a network so that the computer-readable codes can be stored and executed in a distributed fashion.

The terminology used herein is intended to describe exemplary embodiments of the present invention and is not used to limit the scope of the present invention. To aid in understanding the present invention, reference numerals are used in exemplary embodiments shown in the drawings. While particular terms are used to describe exemplary embodiments of the present invention, the present invention is not limited by the particular terms. The present invention can include all elements that can be generally conceived by those of ordinary skill in the art.

The present invention may be embodied as functional blocks and various processing operations. The functional blocks may be implemented with various hardware and/or software configurations executing particular functions. In a manner similar to that in which the elements of the present invention can be executed with software programming or software elements, the present invention can be implemented with a scripting language or a programming language including C, C++, Java, assembler, etc., including various algorithms implemented by a combination of data structures, processes, routines, or other programming elements. The functional aspects can be implemented by algorithms executed in one or more processors. Also, the present invention can employ related art to set an electronic environment, process signals, and/or process data. The terms “mechanism,” “element,” “means,” and “configuration” can be broadly used and are not limited to mechanical and physical configurations. The terms may have the meaning of a series of software routines in conjunction with a processor and so on.

For conciseness of the specification, descriptions of existing electronic configurations, control systems, software, and other functional aspects of the systems may be omitted. Also, connections of lines or connection members between elements depicted in the drawings represent functional connections and/or physical or circuit connections by way of examples. In actual devices, the connections of lines or the connection members can be represented as various replaceable or additional functional connections, physical connections, or circuit connections. Furthermore, unless an element is mentioned with specific terms, such as “essential” or “important,” the element may be an element not necessarily required to apply the present invention.

While the present invention has been described with reference to exemplary embodiments shown in the drawings, it will be understood by those of ordinary skill in the art that the exemplary embodiments are mere examples and various changes and other equivalent embodiments can be made from the exemplary embodiments. Therefore, the technical spirit of the present invention should be determined by the claims and equivalents thereof.

What is claimed is:

1. A method of ordering products or services for a group of purchasers using respective electronic communications devices of each of the group of purchasers, the method comprising:
responsive to an ordering server detecting a first electronic communications device of a first purchaser logging onto a sales interface for a plurality of products or services, the ordering server using previously compiled data with respect to the first purchaser to generate a first purchaser group comprising a plurality of members including the first purchaser;
the ordering server receiving first order information for a first of the plurality of products or services from the first electronic communications device of a first purchaser;
the ordering server separately receiving second order information for a second of the plurality of products or services from at least one electronic communications device of at least one member of the first purchaser group;
the ordering server determining a second purchaser group consisting of the first purchaser and the at least one member whose at least one electronic communications device has separately transmitted the second order information;
the ordering server generating group order information by consolidating the first order information and the second order information; and
the ordering server making an order by transferring the group order information to a seller terminal of a seller,
wherein the ordering server sets whether to open up order details included in the order information received from at least one electronic communications device of the at least one member, according to purchasers.

2. The method of claim 1, wherein the previously complied data includes acquaintances personally designated by the first purchaser.

3. The method of claim 1, wherein the previously complied data includes acquaintance information received from the first communications device of the first purchaser, first persons within a predetermined distance from the first purchaser, and/or first purchaser selection information of purchasers.

4. The method of claim 3, wherein the members of the first purchaser group are the first persons who are at least within the predetermined distance from the first purchaser or second persons that have experiences with making a group order with the first purchaser.

5. The method of claim 1, wherein the previously compiled data includes personal information of the first purchaser including at least one of location information of the first purchaser, purchase history information, social network subscription information, residence information, workplace information, contact information stored in the electronic communications device, and subscription information of a particular service provider.

6. The method of claim 1, wherein the group order information includes order identifiers, ordered product information, and time information related to preparation of ordered products, and
the order identifiers and the time information related to preparation of the ordered products included in the group order information are used by the seller to prepare the ordered products so that at least one member of the second purchaser group can be provided with the ordered products at a sales spot.

7. A method of ordering products or services using respective electronic communications devices of purchasers, the ordering method comprising:
responsive to an ordering server detecting one of more of a plurality of electronic communications devices of a plurality of purchasers logging onto a sales interface for a plurality of products or services, the ordering server using previously compiled data with respect to the plurality of purchasers to generate a purchaser group comprising of a plurality of members that includes ones of the plurality of purchasers for which a condition for making a group order among the plurality of purchasers is satisfied;
the ordering server receiving respective order information for at least one of the plurality of products or services from one or more of the plurality of members of the purchaser group through respective electronic communications devices of the one or more of the plurality of members of the purchase group;
the ordering server setting whether other members of the purchaser group can access details included in the respective order information based on a respective selection, by the one or more of the plurality of members of the purchaser group, of information within the respective order information not to be opened up to the other members of the purchaser group;
the ordering server transmitting to the respective electronic communications devices of the one or more of the plurality of members of the purchase group a notification message for notifying the one or more of the plurality of members of the purchase group that the other members of the purchases group have made an order;
the ordering server compiling the order information from the one or more of the plurality of members into group order information; and
transmitting the group order information to a seller terminal of a seller,
wherein the information selected by the one or more of the plurality of members of the purchaser group not to be opened up to the other members of the purchaser group is kept private from and not transmitted to the respective electronic communications devices of the other members of the purchaser group.

8. The method of claim 7, wherein the condition for making the group order is that purchasers be at least within a predetermined distance from the seller, have been registered in contact lists of each other's electronic communications devices, subscribe to and identical social network, or have had experiences with making a group order together.

9. The method of claim 7, further comprising the ordering server transmitting a condition for purchase and a current state of purchase to each of the plurality of members of the purchase group in real time every time order information is received.

10. The method of claim 7, wherein the group order information includes order identifiers, ordered product information, and time information related to preparation of ordered products, and
the order identifiers and the time information related to preparation of the ordered products included in the group order information are used by the seller to prepare the ordered products so that at least one member of the purchase group can be provided with the ordered products at a sales spot.

11. The method of claim 7, further comprising:
The ordering server receiving payment information of separate orders from the respective electronic communications devices of each of the plurality of members of the purchaser group and making payment between at least one of the respective electronic communications devices of each of the plurality of members of the purchaser group and the server; and
the ordering server making payment for the orders to the seller terminal after the purchaser-server payment operation.

12. The method of claim 11, wherein, when an incentive for the orders is provided by the seller, the incentive is distributed to each of the plurality of members of the purchaser group by the server under predetermined rules.

13. A server for collectively processing a plurality of order information for products or services through electronic communications devices of purchaser, the server comprising:
a communication port configured to receive first order information for a first of a plurality of products or services from a first electronic communications device of a first purchaser and separately receive second order information for a second of the plurality of products or services from a second electronic communications device of at least one member of a first purchaser group that is different form the first purchaser;
a processor configured to determine the first purchaser group responsive to detecting the first electronic communications device logging onto a sales interface for the plurality of products or services, the ordering server using previously compiled data with respect to the first purchaser to generate the first purchaser group to comprise a plurality of members including the first purchaser, and determine a second purchaser group comprising the first purchaser and the at least one members of the first purchaser group whose electronic communications devices separately transmitted the second order information; and
a memory configured to store information related to members of the first and second purchaser groups;
wherein the processor is configured to generate group order information by consolidating the first order information and the second order information,
wherein the processor sets whether other members of the first purchaser group can access details included in the second order information based on a selection by the at least one member of the first purchaser group of information within the second order information not to be opened up to other members of the first purchaser group, and
wherein the information selected by the at least one member of the first purchaser group not to be opened up to other members of the first purchaser group is kept private from and not transmitted to the other electronic communications devices of the other members of the first purchaser group.

14. The server of claim 13, wherein the members of the first purchaser group are persons for which the previously compiled data indicates they are at least within a predetermined distance from the first purchaser, are within a predetermined distance from a seller, have been registered in a contact list of the first purchaser, have had experiences with making a group order with the first purchaser, or subscribe to an identical social network as the first purchaser.

15. The server of claim 13, wherein the first and second purchaser groups are created according to a seller of products or services.

16. The server of claim 13, wherein the processor is further configured to analyze a time needed for a representative purchaser selected from among the members of the second purchaser group to arrive at a seller of the products or services based on location information of electronic communications device of the representative purchaser, the location information being included in the first order information or the second order information.
